(19) United States
(12) Patent Application Publication
(10) Pub. No.: US 2023/0036730 A1
(43) Pub. Date: Feb. 2, 2023

(54) TOKENIZATION OF EXPERT TIME FOR SOFT SKILL DEVELOPMENT

(71) Applicant: GLF CONSULTING FZ, LLC, Fujeirah (AE)

(72) Inventor: Sallyann Della Casa, Jumeirah (AE)

(73) Assignee: GLF CONSULTING FZ, LLC, FUJEIRAH (AE)

(21) Appl. No.: 17/964,535

(22) Filed: Oct. 12, 2022

Related U.S. Application Data
(63) Continuation-in-part of application No. 16/517,994, filed on Jul. 22, 2019, now abandoned.
(60) Provisional application No. 62/701,798, filed on Jul. 22, 2018.

(51) Int. Cl. G06Q 20/36; G06Q 10/02

(52) U.S. Cl. CPC G06Q 20/363; G06Q 20/3678; G06Q 10/02; H04L 2209/56; G06Q 2220/00

(57) ABSTRACT

A system and method for individual skill assessment are provided, allowing the individual to track a dynamic score corresponding to one or more skills and map that score to expected or desirable scores for individual institutions and markets. The system thereby provides for identification of strengths and weaknesses of an individual. The system provides for tokenization of meeting time with one or more skill experts in order to efficiently train one or more of a user's skills.

### CROSS REFERENCES TO RELATED APPLICATIONS

This application is related to and claims priority from the following U.S. patents and patent applications. This application is a continuation-in-part of U.S. patent application Ser. No. 16/517,994, filed Jul. 22, 2019, which claims priority to and the benefit of U.S. Provisional Patent Application No. 62/701,798, filed Jul. 22, 2018, each of which is incorporated herein by reference in its entirety.

### BACKGROUND OF THE INVENTION

### 1. Field of the Invention

The present invention relates to systems and methods for evaluating and improving skills, and more specifically to tokenized engagement with skill experts for developing one or more types of skills.

### 2. Description of the Prior Art

It is generally known in the prior art to provide online learning platforms for developing knowledge and online assessments for evaluating that knowledge.

Prior art patent documents include the following:

U.S. Pat. No. 11,055,667 for Internet-based method and apparatus for career and professional development via structured feedback loop by inventor Pande, filed May 13, 2019 and issued Jul. 6, 2021, discloses methods and an apparatus for generating feedback, reviewing feedback, and conducting interviews by use of VMocks. A VMock, or Virtual Mock, is a virtual profile of a candidate that includes resume, text, video and a document. VMock profiles may be created that have one or more VMocks. Contacts associated with the VMock profile may be managed. Feedback may be requested from the contacts concerning the one or more VMocks, who may then generate the requested feedback. The feedback may then be reviewed. This feedback process may be performed in the context of interviews for employment opportunities and in other similar situations.

U.S. Pat. No. 11,328,231 for Method of matching employers with job seekers by inventors Smith et al., filed Apr. 9, 2021 and issued May 10, 2022, discloses a method of facilitating a match between an employer with at least one job opening and job seekers. The employer has a set of position preferences related to the job opening. The job seekers have suitability data, resumes, etc., that are provided to the employer. The suitability data includes normalized assessment data. The method includes the steps of: determining a position quotient based on the position preferences; deriving a performance quotient for each job seeker, the performance quotient including normalized assessment data; comparing each the performance quotient to the position quotient; and ranking each the job seeker based on the comparison of the performance quotient to the position quotient.

US Patent Publication No. 2019/0251477 for Systems and methods for assessing and improving student competencies by inventors Crosta et al., filed Feb. 15, 2019 and published Aug. 15, 2019, discloses a skills learning method for a student gathering objective data relating to the student in response to various stimuli, and producing a predicted feedback units as a function of the objective data using a machine learning-base classifier. The method can include training a neural network using objective data of student interactions and associated subjective assessments of a skill of each objective data. The method includes receiving a new dataset with objective data of a new student and an associated subjective assessment of a skill of the first student represented by the new objective data. A predicted assessment of the skill of the new objective data is calculated by inputting the new objective data into the neural network. The method can include updating the neural network by combining the initial dataset and the new dataset and recompiling the neural network to fit the model dataset based on a learning algorithm.

U.S. Pat. No. 8,386,481 for System and method for candidate assessment by inventors Croner, filed Oct. 12, 2007 and issued Feb. 26, 2013, discloses a computer-implemented candidate assessment system to identify the drive characteristics of a candidate having taken a personality test. The system includes a characteristic identification engine configured to identify at least a candidate achievement score, a candidate competitiveness score, and a candidate optimism score, a candidate assessment engine configured to determine a drive core skill score based on a combination of the candidate achievement score, candidate competitiveness score, and candidate optimism score. The drive score is determined with weighting using the achievement score. The system also includes a reporting engine configured to generate a profile report including the drive core skill score.

US Patent Publication No. 2021/0097634 for Systems and methods for selecting a training program for a worker by inventors Geffen et al., filed Sep. 26, 2019 and published Apr. 1, 2021, discloses a system and method for selecting a training program from a plurality of training programs for a selected worker including evaluating performance improvement of a plurality of workers who have taken training programs of the plurality of training programs, and associating a performance improvement grade to each of the workers for each of the training programs the worker has taken; selecting, in a worker database, workers that are similar to the selected worker; and selecting the training program for the selected worker based on the performance improvement grades associated with the similar workers for the plurality of training programs.

US Patent Publication No. 2012/0028230 for Teaching method and system by inventor Devereux, filed Jul. 28, 2010 and published Feb. 2, 2012, discloses a system and method for enhancing the identification of soft-skill, self-awareness, self-esteem and confidence learning needs, the development of and monitoring of improvement in self-awareness, self-esteem and confidence attributes. A method comprises establishing a baseline measurement of self-awareness, self-esteem and confidence attributes in the individual by presenting the individual a series of self-awareness, self-esteem and confidence specific questions or statements requiring multiple choice or graded responses and recording the responses; identifying from the baseline measurement specific self-awareness, self-esteem and confidence attributes in need of improvement; optionally communicating the specific self-awareness, self-esteem and confidence attribute improvement needs identified to the individual or a teacher or coach thereto; providing to and/or facilitating the individual one or a plurality of self-awareness, self-esteem and confidence raising exercises or learning modules designed to address the self-awareness, self-esteem and confidence attribute improvement needs of the individual; establishing a revised measurement of self-awareness, self-esteem and confidence attributes in the individual by presenting the individual a series of self-awareness, self-esteem and confidence specific questions or statements requiring multiple choice or graded responses and recording the responses; and comparing the revised measurement with the baseline measurement and reporting any change.

US Patent Publication No. 2015/0302335 for System and method for evaluating leadership abilities and identifying leadership talent among users and organizations in a social network by inventor Unda, filed Apr. 16, 2014 and published Oct. 22, 2015, discloses a system and method for evaluating leadership abilities and identifying leadership talent among users and organizations in a social network, and to compare the leadership abilities of a user to the leadership abilities of other users or categories of users in a social network. The system includes: (1) a user account module configured to create a user profile, (2) a rater invite module configured to send requests for a single evaluation or multiple/subsequent evaluations from individuals that serve on the user's “leadership panel,” (3) a rater categorization module configured to categorize raters in relation to the user, (4) a user request module configured to allow a user to request to evaluate another user, (5) an evaluation module configured to submit ratings of leadership attributes and competencies received from raters or as an optional self-evaluation using a five-point rating scale, and (6) a computation module to capture and update ratings, compute an overall leadership score, assess leadership performance, and determine the “leadership zone” within which an individual falls based on their overall leadership score and number of ratings. Segmentation of users by defined zones allows for the identification of high performance leaders based on experiential input from individuals that have knowledge and observations of the leader and reflects the aggregated assessment of an individual's leadership qualities.

US Patent Publication No. 2004/0153355 for Method and system for assessing leadership skills by inventors Deering et al., filed Jan. 31, 2003 and published Aug. 5, 2004, discloses a method and system for an organization and/or employer to evaluate the leadership skills of individuals and/or employees, and to compare the leadership skills of individuals to average leadership skills for the employer's organization and/or industry. Individual personality and behavioral data from the employer and/or other sources are evaluated to determine two scores, one rating management skills and the other rating experience level. A graph comparing each individual to baseline management skill averages for the organization and/or the relevant industry, to baseline experience level averages for the organization and/or the relevant industry, and to a best fit line generated from multiple individual personality and behavioral data is generated. Individuals can then be grouped into categories based on combinations of high and low management skills and high and low experience level. The category within which an individual falls reflects the individual's assessed leadership qualities.

US Patent Publication No. 2021/0133247 for Content discovery using a skills graph by inventors Chen et al., filed Jan. 4, 2021 and published May 6, 2021, discloses a system including a database configured to store skills graphs for courses, a skills mapping service configured to map skills to courses, a skill query service configured to receive a skill identifier associated with a skill, and return an ordered list of courses. The system further includes a graph service configured to generate skills graphs and store the skills graphs in the database, and a recommendation service configured to traverse skills graphs stored in the graph database, identify one or more courses that are tagged with the skill identifier associated with the skill, and provide the ordered list of courses to the skill query service.

US Patent Publication No. 2020/0175455 for Classification of skills by inventors Gee et al., filed Nov. 30, 2018 and published Jun. 4, 2020, discloses a skills classification system configured to calculate, for a skill from the skills database, industry-specific probabilities for the industries associated with the skill. An industry-specific probability for an industry with respect to a skill is the probability of that skill being a required skill for a job associated with that industry. The skills classification system also calculates an industry-agnostic probability with respect to that same skill, which is the probability of the skill being a required skills for any job regardless of the industry. Based on the distance between the set of industry-specific probabilities for the industries associated with the skill and the industry-agnostic probability, the skills classification system calculates a score for the skill. This score is used to determine whether the skill should be tagged with a soft skill identifier or a hard skill identifier.

US Patent Publication No. 2016/0307456 for Methods and systems for teaching and training people by inventor Harward, filed Mar. 18, 2016 and published Oct. 20, 2016, discloses methods and systems for teaching and training people. Identifying a desired training outcome of a customer entity, identifying existing training information of the customer entity, identifying the customer entity's training needs, organizing the customer entity's training needs into training topics, developing a training instruction for each of the training topics, identify a topic master for providing support to learners, distributing a first training instruction associated with a training topic to the topic master, training the topic master to become a master of the training topic, asynchronously distributing a second training instruction associated with the training topic to a plurality of learners, assisting, by the topic master, each of the plurality of learners to learn using the second training instruction, evaluating the training progress of each of the plurality of learners compared to the desired training outcome and communicating to the topic master the training progress of each of the plurality of learners is disclosed.

US Patent Publication No. 2014/0172732 for Psychographic based methods and systems for job seeking by inventor Baladi, filed Dec. 14, 2012 and published Jun. 19, 2014, discloses a computer-implemented method for job seeking. The method includes receiving a user request to search job openings, which request includes desired work field and user education information. Responsive to the user request, the user is prompted to provide information comprising one or more assertions associated with the user preferences with respect to one or more skills, abilities, work activities and one or more work styles. Further, based on the user request and the provided information, scores associated with a plurality of predetermined occupations are calculated. The scores identify how the user is favorable for every predetermined occupation. The method then identifies and displays a list of predetermined occupations being the most favorable for the user. The user is then prompted to select one or more predetermined occupations, and responsive thereto, the user is selectively provided with a list of j ob openings associated with the selected predetermined occupations.

US Patent Publication No. 2006/0199163 for Dynamic teaching method by inventor Johnson, filed Mar. 2, 2006 and published Sep. 7, 2006, discloses a computerized course module creation system that assists an instructor in creating a course modules with lessons and test questions that assess user competency of predefined skills. The skill is created by breaking down the skill into component parts. Once created, the skill can be modified and saved for future use in different course modules. Additionally, a course or a course module is saved and can be used by the instructor's students or another instructor's students. Furthermore, a royalty payment for use of a course model can be shared by a combination of the creator the course module, an educational institutional hosting the creation of the course model, and an instructor teaching a class utilizing the course module.

US Patent Publication No. 2021/0027233 for Skill validation by inventors Yan et al., filed Jul. 24, 2019 and published Jan. 28, 2021, discloses apparatuses, computer readable medium, and methods for verifying skills of members of an online connection network. The apparatus, computer readable medium, and methods may include a method including responding to a first member of the online connection network indicating a skill possessed by the first member by selecting a skill verification user interface (UI) to present to a second member of the online connection network where the first member and the second member are connected via the online connection network. The method may further include presenting the skill verification UI to the second member, where the skill verification UI presents an indication of the first member, an indication of the skill, and a query regarding a competence level of the skill possessed by the first member. The method may further include receiving a response to the query and determining a skill validation value of the skill for the first member based on the response and a machine learning model.

US Patent Publication No. 2019/0080293 for Method and system for supplementing job postings with social network data by inventors Panigrahi et al., filed Nov. 9, 2018 and published Mar. 14, 2019, discloses systems and methods for leveraging existing sources of information to supplement and enhance job opening postings and other types of business postings. A plurality of sources, including social network sites, talent profiles, and/or surveys and questionnaires are accessed in order to retrieve data relating to a business object. The retrieved data is transformed, such that it may be used to supplement job opening postings and other types of postings with job description data, work culture data, and other business-related data in order to build a social brand for the business.

US Patent Publication No. 2018/0247271 for Value of content relevance through search engine optimization by inventors Hoang et al., filed Feb. 28, 2017 and published Aug. 30, 2018, discloses a system configured to determine the impact on ranking of one or more job postings in view of the relevancy of the terms used by the one or more job postings. Using predetermined keywords, the system obtains search results from a variety of sources, and then vectorizes the contents of those search results. Vectorizing may include removing syntactic language and converting the search results to a plain text format. The system further determines relevant terms from the vectorized search results for each of the predetermined keywords, and then computes relevancy values for each of the predetermined keywords using the relevant terms. Through regression modeling, the system determines regression coefficients given the relevancy values and the sources of the search results. The regression coefficients indicate the impact that relevancy of the terms used in the job postings has on the ranking of the job postings.

U.S. Pat. No. 10,521,772 for Personalized job search and recommendations using job seeker behavioral features by inventors Arya et al., filed Oct. 17, 2016 and issued Dec. 31, 2019, discloses a user submitting a job search query in an online social networking system. The online social networking system calculates a score based on the similarity between the job search query and the profile of the user. When the score transgresses a threshold, the job search query is enhanced by adding data from the profile of the user to the job search query. The job search query is then used to search for, identify, and display jobs in the online social networking system.

US Patent Publication No. 2017/0228561 for Systems and methods for identifying relevant personnel over a network by inventor Nathan, filed Apr. 25, 2017 and published Aug. 10, 2017, discloses a system for identifying personnel within an organization, which is implemented on a computer network of the organization and includes: (A) a database that connects to the computer network and includes (i) knowledge, skill, experience or information held by one or more personnel of the organization, and (ii) contact details of the one or more personnel; and (B) one or more processor-enabled devices that connect to the computer network. The one or more processor-enabled devices interrogate the database for a desired knowledge, skill, experience or information held, and where the desired knowledge, skill, experience or information is held by one of the one or more personnel the one or more devices is provided with the identification and/or contact details of that personnel. The system may be connected to other business systems such as logistics systems and human resources systems so as to best select and deploy personnel as required.

US Patent Publication No. 2007/0168335 for Deep enterprise search by inventors Moore et al., filed Jan. 17, 2006 and published Jul. 19, 2007, discloses methods and apparatuses providing a search tool to conduct a deep enterprise search for business objects related to a query received at a search interface. The search tool identifies an object type and an argument, and searches the enterprise via one or more enterprise services for one or more business objects related to the argument of the search string. Results can be particularly formatted to be appropriate for the context and device with which the search was requested.

U.S. Pat. No. 11,126,970 for Method and system for managing, matching, and sourcing employment candidates in a recruitment campaign by inventor Champaneria, filed Apr. 24, 2019 and issued Sep. 21, 2021, discloses a method and system for automating some aspects of a recruiting process, which may implement rules permitting the processes of sourcing candidates, setting up job interviews, and responding to candidate questions to all be automated with a computer. Such a system may match résumés and job descriptions with a scoring system, and may initiate communications between one or more candidates and a recruiter once an appropriate number of matches have been found. The system may then be configured to field responses to commonly asked questions from a question database, and notify the recruiter if a question is asked that it cannot answer, and may further be configured to proactively ask questions to the candidate if desired. This may allow recruiters to focus on the highest level of vetting, and on aspects of the recruitment process such as promoting the hiring company and salary negotiations.

### SUMMARY OF THE INVENTION

The present invention relates to systems and methods for evaluating and improving skills, and more specifically to tokenized engagement with skill experts for developing one or more types of skills.

It is an object of this invention to tokenize expert time in order to efficiently provide small group experiences between learning users and experts.

In one embodiment, the present invention is directed to a system for communication with experts, including a server platform configured for network communication with a plurality of user devices, the server platform generating a plurality of user profiles, wherein each of the plurality of user profiles is associated with at least one cryptocurrency wallet, wherein the server platform mints at least one non-fungible token (NFT) corresponding to time with at least one expert, wherein the server platform includes at least one audio and/or video chat interface, wherein the server platform generates an audio and/or video call between at least one first user profile and at least one second user profile, wherein the server platform automatically verifies that the at least one cryptocurrency wallet associated with the at least one second user profile includes at least one NFT corresponding to time with the at least one first user profile, wherein the server platform automatically transfers one of the at least one NFT corresponding to the time with the at least one first user profile to a burn wallet upon commencement of the audio and/or video call, and wherein the server platform automatically transfers at least one additional NFT of the at least one NFT corresponding to the time with the at least one first user profile to the burn wallet after the audio and/or video call has exceeded a preset duration.

In another embodiment, the present invention is directed to a system for communication with experts, including a server platform configured for network communication with a plurality of user devices, the server platform generating a plurality of user profiles, wherein each of the plurality of user profiles is associated with at least one cryptocurrency wallet, wherein the server platform mints at least one non-fungible token (NFT) corresponding to time with at least one expert, wherein the server platform includes at least one audio and/or video chat interface, wherein the server platform generates an audio and/or video call between at least one first user profile and a plurality of second user profiles, wherein the server platform automatically verifies that the at least one cryptocurrency wallet associated with each of the plurality of second user profiles includes at least one NFT corresponding to time with the at least one first user profile, and wherein, for each of the plurality of second user profiles, the server platform automatically transfers one of the at least one NFT corresponding to the time with the at least one first user profile to a burn wallet upon commencement of the audio and/or video call.

In yet another embodiment, the present invention is directed to a system for communication with experts, including a server platform configured for network communication with a plurality of user devices, the server platform generating a plurality of user profiles, wherein each of the plurality of user profiles is associated with at least one cryptocurrency wallet, wherein the server platform mints at least one non-fungible token (NFT) corresponding to time with at least one expert, wherein the server platform includes at least one audio and/or video chat interface, wherein the server platform generates an audio and/or video call between at least one first user profile and at least one second user profile, wherein the server platform automatically verifies that the at least one cryptocurrency wallet associated with the at least one second user profile includes at least one NFT corresponding to time with the at least one first user profile, wherein the server platform automatically transfers one of the at least one NFT corresponding to the time with the at least one first user profile to a burn wallet upon commencement of the audio and/or video call, and wherein the server platform automatically transmits a warning notification to a user device corresponding to the at least one second user profile before at least one additional NFT is transferred to the burn wallet.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1 illustrates components and computer implemented methods that are found in an individual and candidate assessment system according to one embodiment of the present invention.

FIG. 2 illustrates a block diagram of a server used by the system according to one embodiment of the present invention.

FIG. 3 illustrates a block diagram of a client device used by the system according to one embodiment of the present invention.

FIG. 4 illustrates a block diagram of applications of an individual and candidate assessment system that function as software rules engines according to one embodiment of the present invention.

FIG. 5 illustrates a block diagram of a system database according to one embodiment of the present invention.

FIG. 6A illustrates an individual competency grid according to one embodiment of the present invention.

FIG. 6B illustrates an institutional competency grid according to one embodiment of the present invention.

FIG. 6C illustrates an institutional competency grid according to one embodiment of the present invention.

FIG. 7 illustrates a block diagram of a computer-implemented method for scoring the intuitive skills of a learning individual according to one embodiment of the present invention.

FIG. 8 illustrates a jobs and skills map data record according to one embodiment of the present invention.

FIG. 9 illustrates a block diagram of a computer-implemented individual assessment method according to one embodiment of the present invention.

FIG. 10 illustrates a block diagram of a computer-implemented candidate assessment method according to one embodiment of the present invention.

FIG. 11 illustrates a block diagram of a system for tokenizing meeting time with an expert according to one embodiment of the present invention.

FIG. 12 illustrates a journey map according to one embodiment of the present invention.

FIG. 13 illustrates a node in a journey map according to one embodiment of the present invention.

FIG. 14 is a schematic diagram of a system of the present invention.

### DETAILED DESCRIPTION

The present invention is generally directed to systems and methods for evaluating and improving skills, and more specifically to tokenized engagement with skill experts for developing one or more types of skills.

In one embodiment, the present invention is directed to a system for communication with experts, including a server platform configured for network communication with a plurality of user devices, the server platform generating a plurality of user profiles, wherein each of the plurality of user profiles is associated with at least one cryptocurrency wallet, wherein the server platform mints at least one non-fungible token (NFT) corresponding to time with at least one expert, wherein the server platform includes at least one audio and/or video chat interface, wherein the server platform generates an audio and/or video call between at least one first user profile and at least one second user profile, wherein the server platform automatically verifies that the at least one cryptocurrency wallet associated with the at least one second user profile includes at least one NFT corresponding to time with the at least one first user profile, wherein the server platform automatically transfers one of the at least one NFT corresponding to the time with the at least one first user profile to a burn wallet upon commencement of the audio and/or video call, and wherein the server platform automatically transfers at least one additional NFT of the at least one NFT corresponding to the time with the at least one first user profile to the burn wallet after the audio and/or video call has exceeded a preset duration.

In another embodiment, the present invention is directed to a system for communication with experts, including a server platform configured for network communication with a plurality of user devices, the server platform generating a plurality of user profiles, wherein each of the plurality of user profiles is associated with at least one cryptocurrency wallet, wherein the server platform mints at least one non-fungible token (NFT) corresponding to time with at least one expert, wherein the server platform includes at least one audio and/or video chat interface, wherein the server platform generates an audio and/or video call between at least one first user profile and a plurality of second user profiles, wherein the server platform automatically verifies that the at least one cryptocurrency wallet associated with each of the plurality of second user profiles includes at least one NFT corresponding to time with the at least one first user profile, and wherein, for each of the plurality of second user profiles, the server platform automatically transfers one of the at least one NFT corresponding to the time with the at least one first user profile to a burn wallet upon commencement of the audio and/or video call.

In yet another embodiment, the present invention is directed to a system for communication with experts, including a server platform configured for network communication with a plurality of user devices, the server platform generating a plurality of user profiles, wherein each of the plurality of user profiles is associated with at least one cryptocurrency wallet, wherein the server platform mints at least one non-fungible token (NFT) corresponding to time with at least one expert, wherein the server platform includes at least one audio and/or video chat interface, wherein the server platform generates an audio and/or video call between at least one first user profile and at least one second user profile, wherein the server platform automatically verifies that the at least one cryptocurrency wallet associated with the at least one second user profile includes at least one NFT corresponding to time with the at least one first user profile, wherein the server platform automatically transfers one of the at least one NFT corresponding to the time with the at least one first user profile to a burn wallet upon commencement of the audio and/or video call, and wherein the server platform automatically transmits a warning notification to a user device corresponding to the at least one second user profile before at least one additional NFT is transferred to the burn wallet.

None of the prior art discloses systems for tokenizing time of experts for developing soft skills, 21^{st} century skills, and other skills in one-on-one meetings (or other small groups) with a user.

In an increasingly automated world, the future of employment is a critical question that requires immediate attention. According to statistics from the International Labour Organisation, out of 5 billion people of working age, 192 million are unemployed, 176 million are stuck in extreme poverty, and 1.4 billion are in vulnerable employment. As automation increases, many jobs will no longer require full time employees, but different positions are expected to rise up, replacing these previous employment opportunities. However, such a shift means that making job seeking more efficient is critically important as workers realign their careers. Because there is a large number of new jobs, finding employees with the specific required knowledge or skills to complete the task will likely be increasingly difficult, meaning that soft skills and skills relating to operating modern technology (i.e., 21^{st} century skills) are likely to garner increasing attention as a way to determine candidate quality, rather than specific experience.

It is well known that traditional resumes, school transcripts, personality tests, and other existing individual assessments do not illustrate a full picture of one's true abilities, particularly a person's capabilities, ability to learn, and other so-called “soft skills.” Currently available assessments for an individual commonly fail to take into account a person's inherent strengths and weaknesses and modify modules targeting those strengths and weaknesses. Furthermore, existing individual assessments are unable to provide a learning pathway for intuitive skills and habit building capabilities based on combination of engagement, habit and psychometrics, a ranked searching, and sharing capabilities.

Soft skills and “21^{st} century skills” are becoming more important to employers and educational institutions interested in selecting the best possible candidates for a position, and therefore these skills are becoming important to the candidates, who wish to hone and improve the skills. Generally, 21st century skills are abilities which individuals need to succeed in their careers during the Information Age. Examples of 21st century skills include: critical thinking, creativity and creative thinking, collaboration, communication, information literacy, media literacy, technology literacy, flexibility, leadership, initiative, entrepreneurship, productivity, and social skills. Generally, soft skills are personal attributes that enable someone to interact effectively and harmoniously with other people. Example soft skills include: strong work ethic, positive attitude, judgement and decision making, good communication skills, mindfulness, emotional IQ, time management abilities, problem-solving skills, acting as a team player, self-confidence, self-direction, and ability to accept and learn from criticism.

The conventional method of recruiting talent often relies on experience and feedback of peers. However, it does not take into account the availability or unavailability of appropriate opportunities for individuals to demonstrate their inherent, unique talent. Therefore, a need exists for novel computer-implemented systems and methods for individual and candidate assessment. A further need exists for novel computer-implemented systems and methods that are configured to provide computer implemented competency mapping, education and data processing of individuals, such as employment candidates. There is also a need for novel computer-implemented systems and methods that are configured to illustrate a full picture of an individual's true abilities, particularly a person's capabilities or ability to learn. Finally, a need exists for novel computer-implemented systems and methods that are configured to provide a learning pathway for intuitive skills and habit building capabilities based on combination of engagement, habit and psychometrics, a ranked searching, and sharing capabilities.

Furthermore, a system is needed for developing user's soft skills in an interactive and dynamic way. Such development is optimized through communication with one with high skill in the given field who is able to clearly impart knowledge to the user. However, effectively and efficiently monetizing the time of experts poses a challenge, especially as experts commonly work other jobs, such as regular teaching jobs, research roles, and/or industry jobs. Therefore, a method of ensuring one-on-one time between a learner and an expert is required (or at least, a small meeting between the learner and the expert).

Referring now to the drawings in general, the illustrations are for the purpose of describing one or more preferred embodiments of the invention and are not intended to limit the invention thereto.

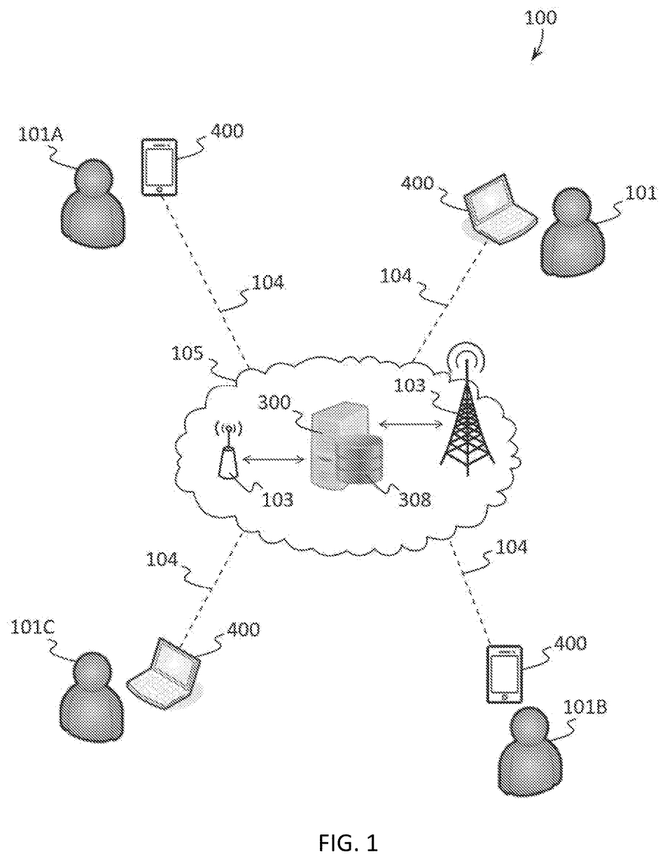

The present invention will now be described by example and through referencing the appended figures representing preferred and alternative embodiments. As perhaps best shown by FIG. 1, an illustrative example of some of the physical components which comprise an individual and candidate assessment system (“the system”) 100 according to some embodiments is presented. The system 100 is configured to facilitate the transfer of data and information between one or more access points 103, client devices 400, and servers 300 over a data network 105. Each client device 400 sends data to and receives data from the data network 105 through a network connection 104 with an access point 103. A data store 308 accessible by the server 300 contains one or more databases. The data comprises any information that one or more users 101 input into the system 100, including information on or describing one or more users 101, information on or describing one or more intuitive skills of a user 101, information on or describing one or more lessons, quizzes, and jobs, information requested by one or more users 101, information supplied by one or more users 101, and any other information provided to a user 101, such as for training, educational, and employment purposes.

Users 101 of the system 100 include one or more learning individuals 101A and one or more peers 101B. Generally, a learning individual 101A comprises an individual that operates a client device 400 for the purposes of exchanging information with the system 100 for the purposes of improving their intuitive skills. Example learning individuals 101A include students of schools, universities, and organizations, and any other person or individual that desires to achieve self-awareness and self-learning. A peer 101B comprises an individual that operates a client device 400 for the purposes of exchanging information with the system 100 for the purposes of providing and/or receiving information on the intuitive skills of one or more learning individuals 101A. For example, peers 101B include coworkers of a learning individual 101A, fellow students of a learning individual 101A, current employer of a learning individual 101A, and prospective employers of a learning individual 101A.

In this example, the system 100 comprises at least one client device 400 (but preferably more than two client devices 400) configured to be operated by one or more users 101. Client devices 400 include mobile devices, such as laptops, tablet computers, personal digital assistants, smart phones, and the like, which are equipped with a wireless network interface capable of sending data to one or more servers 300 with access to one or more data stores 308 over a network 105 such as a wireless local area network (WLAN). Additionally, client devices 400 include fixed devices, such as desktops, workstations, and the like, that are equipped with a wireless or wired network interface capable of sending data to one or more servers 300 with access to one or more data stores 308 over a wireless or wired local area network 105. The present invention is able to be implemented on at least one client device 400 and/or server 300 programmed to perform one or more of the steps described herein. In some embodiments, more than one client device 400 and/or server 300 is used, with each being programmed to carry out one or more steps of a method or process described herein.

In some embodiments, the system 100 is configured to provide a timer-based, habit developing systematic learning environment for a user 101 to build their intuitive skills, such as soft skills and 21st century skills. Generally, 21st century skills are abilities which individuals need to succeed in their careers during the Information Age. Example 21st century skills include: critical thinking; creativity and creative thinking; collaboration; communication; information literacy; media literacy; technology literacy; flexibility; leadership; initiative; entrepreneurship; productivity; and social skills. Generally, soft skills are personal attributes that enable someone to interact effectively and harmoniously with other people. Example soft skills include: strong work ethic; positive attitude; judgement and decision making; good communication skills; mindfulness; emotional IQ; time management abilities; problem-solving skills; acting as a team player; self-confidence; self-direction; and ability to accept and learn from criticism.

In further embodiments, the system 100 is configured to provide benchmarking and measurement of a user's performance and intuitive skills. Benchmarking is achieved with the use of a customized behavior psychometric tool that is used to generate individual competency grids mapping a user's intuitive skills, motivations, values, attitudes and personality factors. Individual learning pathways are then generated for users 101 to access one or more lessons and quizzes, optionally contained in micro learning modules, to build and improve their intuitive skills. The system 100 uses an algorithm that is balanced and takes into consideration frequency of use, engagement with a daily activity, a 360-degree feedback loop, community performance, benchmark testing on various intuitive skills to give a score to the one or more users 101. Preferably, a user 101 or third party tracks and visualizes the user's progress and habits in learning intuitive skills. Optionally, the system 100 enables a user 101 to also share their rankings and skills progress, and the system 100 enables this data to be accessible by third parties in searches of intuitive skills, preferably based on rankings. Additionally, the system 100 comprises a database of mapped intuitive skills and the levels in which they are needed for jobs, which are used to enable a user 101 to build their soft skills specific to a job they desire currently and in the future.

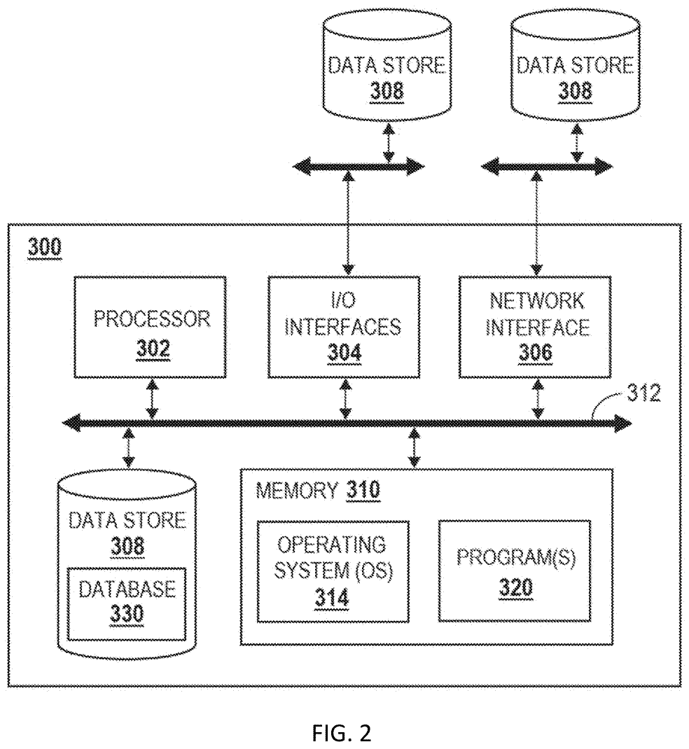

Referring now to FIG. 2, in an exemplary embodiment, a block diagram illustrates a server 300 of which one or more are able to be used in the system 100 or standalone and which are able to be a type of computing platform. The server 300 is a digital computer that, in terms of hardware architecture, generally includes a processor 302, input/output (I/O) interfaces 304, a network interface 306, a data store 308, and memory 310. It should be appreciated by those of ordinary skill in the art that FIG. 2 depicts the server 300 in an oversimplified manner, and a practical embodiment includes additional components and suitably configured processing logic to support known or conventional operating features that are not described in detail herein. The components (302, 304, 306, 308, and 310) are communicatively coupled via a local interface 312. The local interface 312 is, by way of example and not limitation, one or more buses or other wired or wireless connections, as is known in the art. The local interface 312 has additional elements, which are omitted for simplicity, such as controllers, buffers (caches), drivers, repeaters, and receivers, among many others, to enable communications. Further, the local interface 312 includes address, control, and/or data connections to enable appropriate communications among the aforementioned components.

The processor 302 is a hardware device for executing software instructions. The processor 302 is any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 are used to receive user input from and/or for providing system output to one or more devices or components. User input is provided via, for example, a keyboard, touch pad, and/or a mouse. System output is provided via a display device and a printer (not shown). I/O interfaces 304 include, for example, a serial port, a parallel port, a small computer system interface (SCSI), a serial ATA (SATA), a fiber channel, Infiniband, iSCSI, a PCI Express interface (PCI-x), an infrared (IR) interface, a radio frequency (RF) interface, and/or a universal serial bus (USB) interface.

The network interface 306 is used to enable the server 300 to communicate on a network, such as the Internet, the data network 105, the enterprise, and the like, etc. The network interface 306 includes, for example, an Ethernet card or adapter (e.g., 10Base-T, Fast Ethernet, Gigabit Ethernet, 10 GbE) or a wireless local area network (WLAN) card or adapter (e.g., 802.1 1a/b/g/n). The network interface 306 includes address, control, and/or data connections to enable appropriate communications on the network. A data store 308 is used to store data. The data store 308 is a type of memory and includes any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 incorporates electronic, magnetic, optical, and/or other types of storage media. In one example, the data store 308 is located internal to the server 300, such as, for example, an internal hard drive connected to the local interface 312 in the server 300. Additionally, in another embodiment, the data store 308 is located external to the server 300 such as, for example, an external hard drive connected to the I/O interfaces 304 (e.g., SCSI or USB connection). In a further embodiment, the data store 308 is connected to the server 300 through a network, such as, for example, a network attached file server.

The memory 310 includes any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 incorporates electronic, magnetic, optical, and/or other types of storage media. Note that the memory 310 has a distributed architecture, where various components are situated remotely from one another, but are able to be accessed by the processor 302. The software in memory 310 includes one or more software programs, each of which includes an ordered listing of executable instructions for implementing logical functions. The software in the memory 310 includes a suitable operating system (OS) 314 and one or more programs 320.

The operating system 314 essentially controls the execution of other computer programs, such as the one or more programs 320, and provides scheduling, input-output control, file and data management, memory management, and communication control and related services. The operating system 314 is, for example, Windows NT, Windows 2000, Windows XP, Windows Vista, Windows 7, Windows 8, Windows 10, Windows Server 2003/2008/2012/2016 (all available from Microsoft, Corp. of Redmond, Wash.), Solaris (available from Sun Microsystems, Inc. of Palo Alto, Calif.), LINUX (or another UNIX variant) (available from Red Hat of Raleigh, N.C. and various other vendors), Android and variants thereof (available from Google, Inc. of Mountain View, Calif.), Apple OS X and variants thereof (available from Apple, Inc. of Cupertino, Calif.), or the like. The one or more programs 320 are configured to implement the various processes, algorithms, methods, techniques, or other processes as described herein.

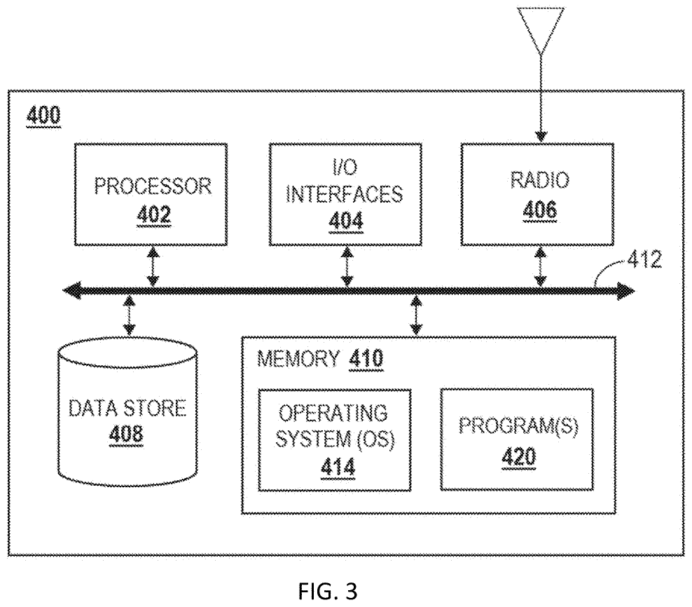

Referring to FIG. 3, in an exemplary embodiment, a block diagram illustrates a client device 400 of which one or more is used in the system 100 or the like and which is a type of computing platform. The client device 400 is a digital device that, in terms of hardware architecture, generally includes a processor 402, input/output (I/O) interfaces 404, a radio 406, a data store 408, and memory 410. It should be appreciated by those of ordinary skill in the art that FIG. 3 depicts the client device 400 in an oversimplified manner, and a practical embodiment includes additional components and suitably configured processing logic to support known or conventional operating features that are not described in detail herein. The components (402, 404, 406, 408, and 410) are communicatively coupled via a local interface 412. The local interface 412 is, by way of example and not limitation, one or more buses or other wired or wireless connections, as is known in the art. The local interface 412 has additional elements, which are omitted for simplicity, such as controllers, buffers (caches), drivers, repeaters, and receivers, among many others, to enable communications. Further, the local interface 412 includes address, control, and/or data connections to enable appropriate communications among the aforementioned components.

The processor 402 is a hardware device for executing software instructions. The processor 402 is able to be any custom made or commercially available processor, a central processing unit (CPU), an auxiliary processor among several processors associated with the client device 400, a semiconductor-based microprocessor (in the form of a microchip or chip set), or generally any device for executing software instructions. When the client device 400 is in operation, the processor 402 is configured to execute software stored within the memory 410, to communicate data to and from the memory 410, and to generally control operations of the client device 400 pursuant to the software instructions. In an exemplary embodiment, the processor 402 includes a mobile optimized processor such as optimized for power consumption and mobile applications.

The I/O interfaces 404 are used to receive data and user input and/or for providing system output. User input is provided via a plurality of I/O interfaces 404, such as a keypad, a touch screen, a camera, a microphone, a scroll ball, a scroll bar, buttons, bar code scanner, voice recognition, eye gesture, and the like. System output is provided via a display screen 404A such as a liquid crystal display (LCD), touch screen, and the like. The I/O interfaces 404 also include, for example, a global positioning service (GPS) radio, a serial port, a parallel port, a small computer system interface (SCSI), an infrared (IR) interface, a radio frequency (RF) interface, a universal serial bus (USB) interface, and the like. The I/O interfaces 404 include a graphical user interface (GUI) that enables a user to interact with the client device 400. Additionally, the I/O interfaces 404 are used to output notifications to a user and include a speaker or other sound emitting device configured to emit audio notifications, a vibrational device configured to vibrate, shake, or produce any other series of rapid and repeated movements to produce haptic notifications, and/or a light emitting diode (LED) or other light emitting element which are configured to illuminate to provide a visual notification.

The radio 406 enables wireless communication to an external access device or network. Any number of suitable wireless data communication protocols, techniques, or methodologies are supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 408 is used to store data and is therefore a type of memory. The data store 408 includes any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 incorporates electronic, magnetic, optical, and/or other types of storage media. The memory 410 includes any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 incorporates electronic, magnetic, optical, and/or other types of storage media. Note that the memory 410 has a distributed architecture, where various components are situated remotely from one another, but are able to be accessed by the processor 402. The software in memory 410 includes one or more software programs 420, each of which includes an ordered listing of executable instructions for implementing logical functions. In the example of FIG. 3, the software in the memory system 410 includes a suitable operating system (OS) 414 and programs 420.

The operating system 414 essentially controls the execution of other computer programs, and provides scheduling, input-output control, file and data management, memory management, and communication control and related services. The operating system 414 is, for example, LINUX (or another UNIX variant), Android (available from Google), Symbian OS, Microsoft Windows CE, Microsoft Windows 7 Mobile, Microsoft Windows 10, iOS (available from Apple, Inc.), webOS (available from Hewlett Packard), Blackberry OS (Available from Research in Motion), and the like.

The programs 420 include various applications, add-ons, etc. configured to provide end user functionality with the client device 400. For example, exemplary programs 420 include, but are not limited to, a web browser, social networking applications, streaming media applications, games, mapping and location applications, electronic mail applications, financial applications, and the like. In a typical example, the end user typically uses one or more of the programs 420 along with a network 105 to manipulate information of the system 100.

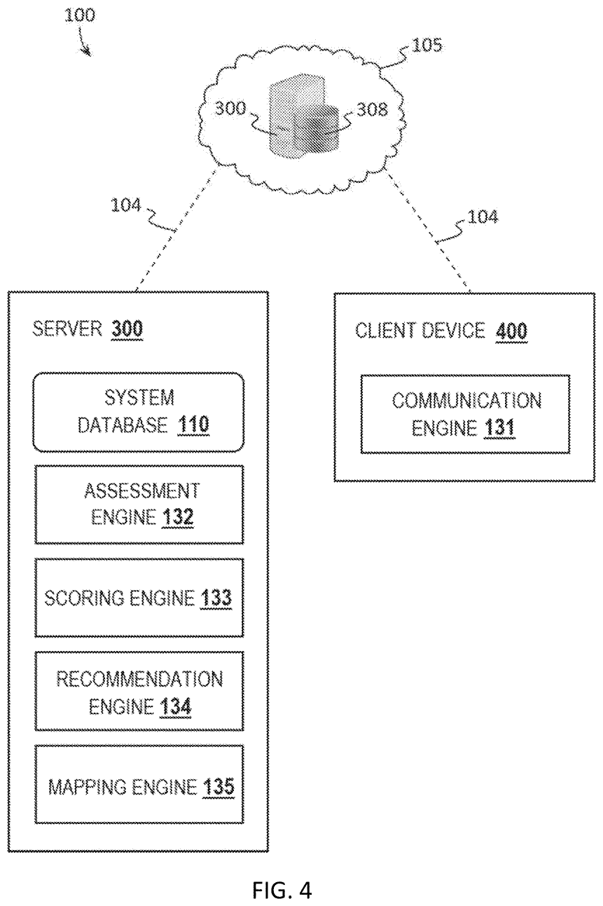

Referring now to FIG. 4 a block diagram showing some software rules engines and components which are found in a system 100 and which are optionally configured to run on one or more servers 300 and/or client devices 400 according to various embodiments described herein are illustrated. A server 300 and a client device 400 are in wired and/or wireless electronic communication through a network 105 with a data store 308. The engines 131, 132, 133, 134, 135, are in electronic communication, so that data is readily exchanged between the engines 131, 132, 133, 134, 135, and one or more engines 131, 132, 133, 134, 135, reads, writes, or otherwise accesses data in one or more system databases 110 of one or more data stores 308.

In this and some embodiments, one or more servers 300 are configured to run one or more software rules engines or programs, such as an assessment engine 132, a scoring engine 133, a recommendation engine 134, and a mapping engine 135, while a client device 400 is configured to run one or more software rules engines or programs, such as a communication engine 131. In other embodiments, a communication engine 131, an assessment engine 132, a scoring engine 133, a recommendation engine 134, and/or a mapping engine 135 are configured to run on one or more client devices 400 and/or servers 300 with data transferred to and from a communication engine 131, an assessment engine 132, a scoring engine 133, a recommendation engine 134, and/or a mapping engine 135 that are in communication with a data store 308 through a network 105. It should be understood that the functions attributed to the engines 131, 132, 133, 134, 135, described herein are exemplary in nature, and that in alternative embodiments, any function attributed to any engine 131, 132, 133, 134, 135, is able to be performed by one or more other engines 131, 132, 133, 134, 135, or any other suitable processor logic.

The system 100 comprises one or more communication engines 131. A communication engine 131 comprises or functions as communication logic stored in a memory 310,410, which is executable by the processor 302, 402, of a server 300 and/or client device 400. Generally, a communication engine 131 is configured to operate an I/O interface 404, such as a display screen 404A (optionally of a touchscreen interface), of a client device 400 operated by a user 101 in order to provide and receive information from the user 101 via a graphical user interface, such as via a notepad. In some embodiments, a communication engine 131 is configured to enable communication between one or more servers 300 and client devices 400. In further embodiments, a communication engine 131 is configured to push notifications of lessons 111 available for a learning individual 101A to the client device 400 of the learning individual 101A. In further embodiments, a communication engine is configured to send or provide user intuitive skill scores 125, rankings, and learning habits to any third party, in any format including social media platforms, such as FACEBOOK and INSTAGRAM, and hiring and networking platforms, such as LINKEDIN, MONSTER, and others. In still further embodiments, a communication engine 131 is configured to operate any of the I/O interfaces 404 of a client device 400 to allow the system 100 to input and output information from and to a user 101 via a client device 400.

In one embodiment, daily assessments are made accessible by the system to each client device. In one embodiment, a maximum number of daily assessments is set (e.g., 3 assessments daily maximum) such that no more than the maximum number is available to be taken each day. In one embodiment, additional assessments are not made available until the previous assessments are completed or a selection is received to reject individual assessments (which causes the rejected assessments to disappear and new assessments to be sent in their place). In one embodiment, a daily maximum and/or total maximum number of assessment rejections is provided for each user 101. By limiting the number of daily assessments and limiting new assessments if previous ones have not been completed, the system automatically prevents the accumulation of additional assessments, reducing chances that a user becomes overwhelmed by the number of assignments they have yet to take.

The system 100 comprises one or more assessment engines 132. An assessment engine 132 comprises or functions as assessment logic stored in a memory 310, 410, which is executable by the processor 302, 402, of a server 300 and/or client device 400. In some embodiments, an assessment engine 132 is configured to select and retrieve one or more quizzes 113, questions 114, and/or lessons 111 from a system database 110 which are provided to the client device 400 of a learning individual 101A by a communication engine 131. In further embodiments, an assessment engine 132 is configured to score quizzes 113, notepad interactions, and other input provided by a learning individual 101A via their client device 400.

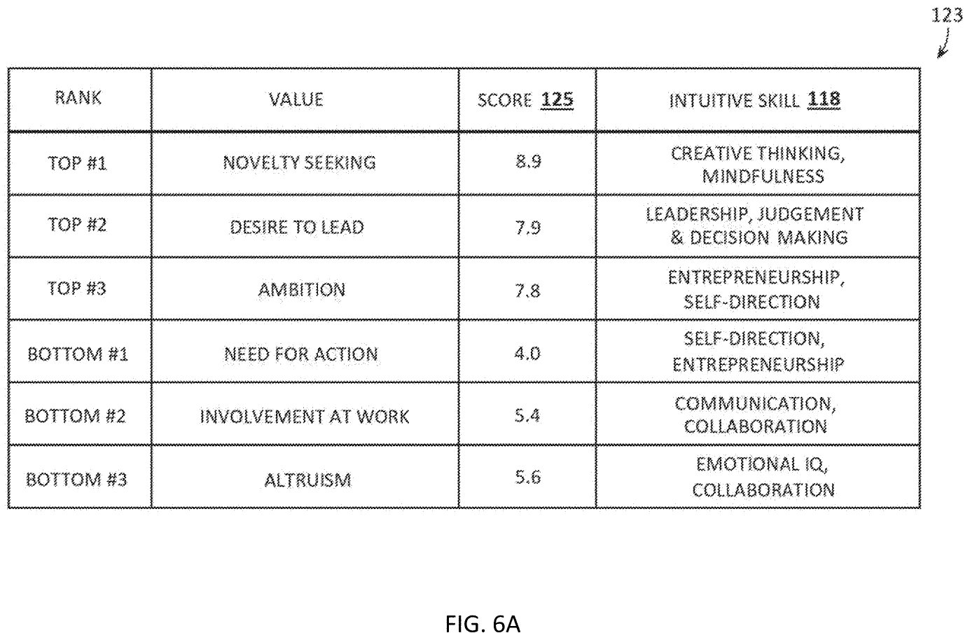

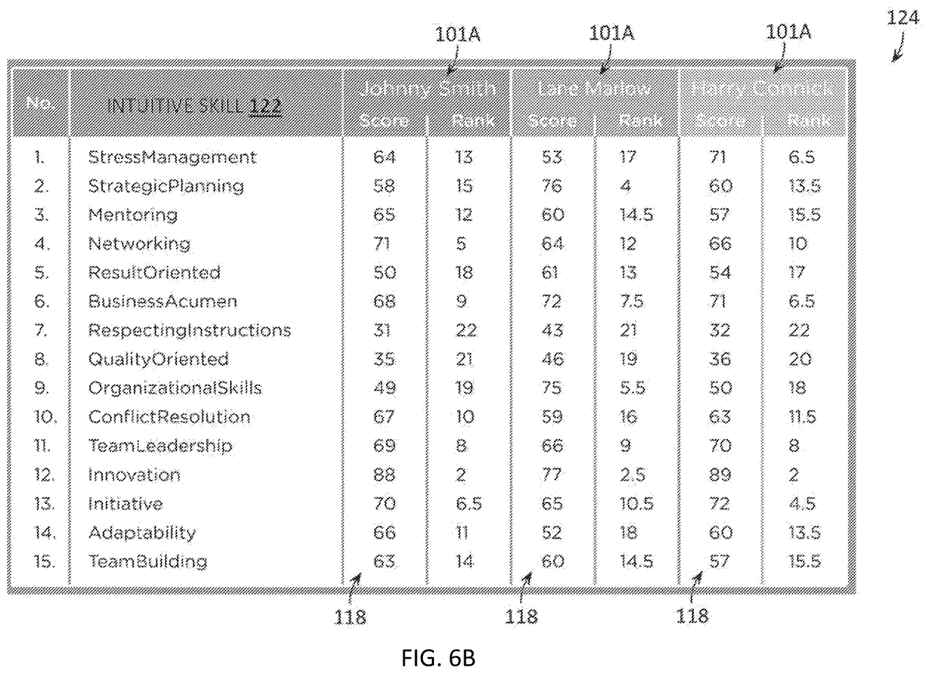

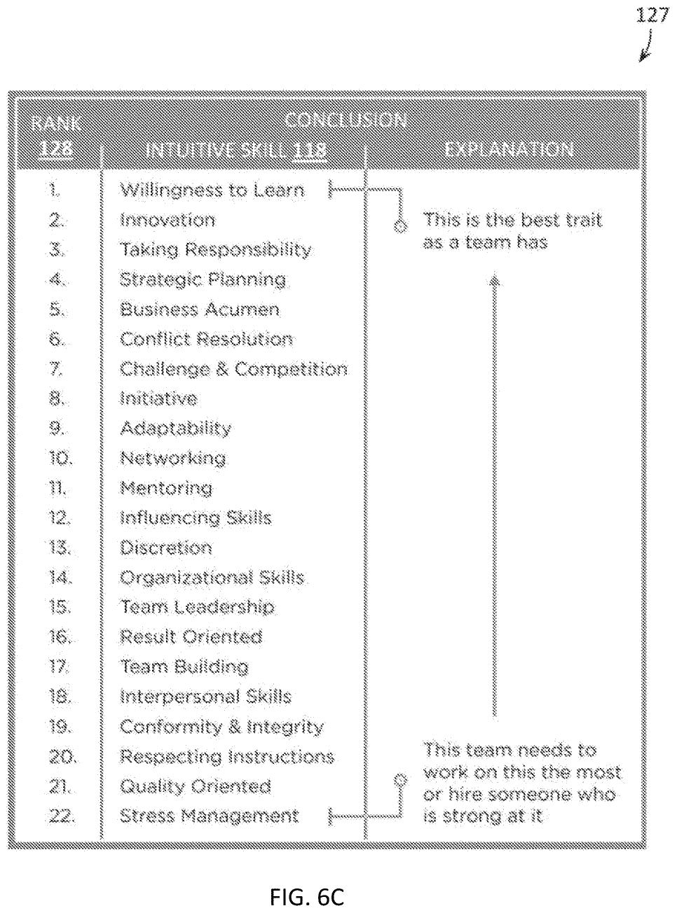

The system 100 comprises one or more scoring engines 133. A scoring engine 133 comprises or functions as scoring logic stored in a memory 310, 410, which are executable by the processor 302, 402, of a server 300 and/or client device 400. In some embodiments, a scoring engine 133 is configured to score a learning individual's 101A input that they provide in response to activities 112, quizzes 113, and lessons 111 via a communication engine 131. In further embodiments, a scoring engine 133 is configured to score a peer's 101B input that they provide in response to queries about the intuitive skills 118 of a learning individual 101A via a communication engine 131. In further embodiments, a scoring engine 133 is configured to generate an individual competency grid 123 (a competency grid showing intuitive skills 118 of a single learning individual 101A) using the individual's intuitive skills scores 125 as shown in FIG. 6A. In some embodiments, a scoring engine 133 is configured to generate an institutional competency grid 124 of two or more learning individual's intuitive skills scores 125 in an organization, such as for each employee in a group, department, or company as shown in FIG. 6B.

The system 100 comprises one or more recommendation engines 134. A recommendation engine 134 comprises or functions as recommendation logic stored in a memory 310,410, which is executable by the processor 302, 402, of a server 300 and/or client device 400. In some embodiments, a recommendation engine 134 is configured to select one or more activities 112, lessons 111, and/or quizzes 113, which are provided to a learning individual 101A based on the intuitive skills 118 and scores 125 of the learning individual 101A. In further embodiments, a recommendation engine 134 is configured to create one or more learning pathways 119, which comprise one or more activities 112, lessons 111, and/or quizzes 113 for a learning individual 101A to perform or receive. In further embodiments, a recommendation engine 134 is configured to recommend jobs 121 for a learning individual 101A based on the intuitive skills 118 and scores 25 of the learning individual 101A.

The system 100 comprises one or more mapping engines 135. A mapping engine 135 comprises or functions as mapping logic stored in a memory 310, 410, which is executable by the processor 302, 402, of a server 300 and/or client device 400. In some embodiments, a mapping engine 135 is configured to map job intuitive skills 122 and scores 126 to jobs 121. In further embodiments, a mapping engine 135 is configured to map job intuitive skills 122 and scores 126 to jobs 121 that are listed by third party employment platforms, such as LINKEDIN, MONSTER, INDEED, and other similar sites.

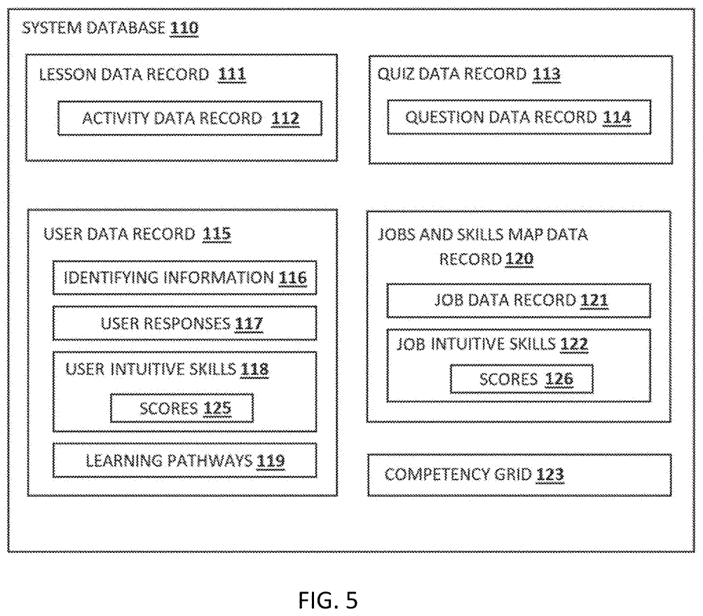

Turning now to FIG. 5, the system 100 comprises one or more databases, such as a system database 110, which is stored on a data store 308 accessible to one or more engines 131, 132, 133, 134, 135. In some embodiments, a system database 110 comprises information that one or more users 101 desire to input into the system 100, including information provided by one or more users 101, such as information on or describing one or more intuitive skills 118 and scores 125 of users 101, information in response to one or more activities 112, lessons 111, quizzes 113, and/or queries, information on or describing one or more job intuitive skills 122 and scores 126, information on or describing one or more jobs 121, information on or describing one or learning pathways 119, and any other information which a user 101 provides or is provided with for the purposes of promoting behavioral change and improving the focused attention daily of the users 101. It should be understood that the described structure of the system database 110 is exemplary in nature, and that in alternative embodiments, the data contained within the system database 110 is able to be organized in any other way.

In some embodiments, a system database 110 comprises one or more, such as a plurality of, lesson data records (“lessons”) 111. Generally, a lesson 111 comprises one or more activity data records (“activities”) 112 which are provided to a learning individual 101A and which the learning individual 101A interacts with, such as via a virtual notepad, keyboard, and/or other I/O interface 404A in order to maintain or improve an intuitive skill of the learning individual 101A. For example, an activity 112 comprises a game, written passage, video, etc., which a learning individual 101A plays, reads, watches, or otherwise interacts with, to improve the intuitive skill of critical thinking.

In some embodiments, a system database 110 comprises one or more, such as a plurality of, quiz data records (“quizzes”) 113. Generally, a quiz 113 comprises one or more question data records (questions”) 114 which are provided to a learning individual 101A for the purposes of ascertaining one or more intuitive skills or other information of the learning individual 101A, preferably based on one or more lessons 111 provided to the learning individual 101A. A learning individual 101A provides input in response to the questions 114 via a virtual notepad, keyboard, and/or other I/O interface 404A and the input is scored in order to ascertain one or more intuitive skills of the learning individual 101A.

In some embodiments, a system database 110 comprises one or more, such as a plurality of, user data records 115. Generally, a user data record 115 comprises information describing a user 101, such as a learning individual 101A or a peer 101B. In some embodiments, user data records 115 comprise one or more data fields, such as identifying information 116, user responses 117, user skills 118, and/or learning pathways 119. Identifying information 116 includes a name, a user name, password, other login information, physical address, email address, phone number, client device 400 information, and/or any other information which is able to be used to identify the user 101 of the user data record 115. User responses 117 include input provided by the user 101 in response to lesson 111 queries or questions, activity 112 queries or questions, quiz 113 queries or questions, and any other queries or questions. User skills 118 describe the level of one or more intuitive skills, rate of change, or progress over time of one or more intuitive skills, and any other information which is used to measure and describe the intuitive skills of the user 101. Learning pathways 119 describe one or more lessons 111, activities 112, quizzes 113, and any other information which is provided to the user 101 in order to improve or maintain one or more intuitive skills.

In some embodiments, a system database 110 comprises one or more, such as a plurality of, jobs and skills map data records (jobs and skills maps) 120. Generally, a jobs and skills map 120 comprises one or more jobs 121 with one or more job intuitive skills 122 and a score 126 preferably for each job intuitive skill 122 associated with each job 121. A job data record (“job”) 121 comprises information describing a job, position, role, occupation, task, and the like, which a person, such as a user 101, performs. An intuitive skill data record (“job intuitive skill”) 122 comprises information describing an intuitive skill 122 which is used and/or not used by an individual performing that job 121. In preferred embodiments, the system database 110 comprises an individual competency grid 123 for each learning individual 101A which comprises a listing of two or more intuitive skills 122 of the learning individual 101A and a measurement or score 126 for each intuitive skill 122. Preferably, the score 126 for each intuitive skill 122 of a job 121 describes a threshold value or minimum value that a user intuitive skill 118 score 125 should preferably meet or exceed to successfully perform the job 121. In further embodiments, the system database 110 comprises a plurality of jobs and skills map 120 data records which functions as a database of mapped intuitive skills 122 and the levels or scores 126 in which they are needed for jobs 121 which are used to provide one or more lessons 111, activities 112, and/or quizzes 1113, which are used by a learning individual 101A to build their user intuitive skills 118 (and scores 125) specific to a job 121 they desire currently and in the future, preferably so that the user intuitive skills 118 scores 125 meet or exceed the scores 126 for each intuitive skill 122 associated in the jobs and skills map 120 data record of that job 121.

In some embodiments, the system 100 enables a learning individual 101A to use their client device 400 to Build, Measure, Track, Visualize, Search and Share their intuitive skills 118 and scores 125 concurrently. In some embodiments, a plurality of lessons 111, in various intuitive skills 118 categories are uploaded to the system database 110, optionally on a server 300, and the lessons 111 are available for completion by learning individual 101A on various time intervals, such as one per day or for a 24-hour time span, two per week, or any other time period, via various digital client devices 400, such as computers, tablets, laptops, smartphones, and the like. In some embodiments, a learning individual 101A has a limited time period to complete a lesson 111, such as ten minutes to work on an activity 112, and/or complete a quiz 113. In preferred embodiments, the communication engine 131 sends push notifications to the client device 400 of a learning individual 101A, such as two times a day, reminding the learning individual 101A about the time they have before the lessons 111, activities 112, and/or quizzes 113 expire (so as to be unavailable to the user 101 and/or unavailable for scoring purposes).

In preferred embodiments, each activity 112 requires a learning individual 101A to use a virtual notepad, which is implemented as a space on the client device 400 display screen 404A, which the user learning individual 101A accesses with their keyboard, digital pen, finger touch, and/or other input means, to write their answers and thoughts regarding the lesson 111 and activities 112 being offered on that day, built into the system 100 to respond. In preferred embodiments, the assessment engine 132 comprises a timer that clocks the engagement on each activity 112 of the learning individual 101A. Upon completion of an activity 112, the learning individual 101A has the option to answer questions 114 in a self-review and also has the option to send it to another user 101, such as a peer 101B, by inputting or selecting their email, name, phone number, or other unique identifier and sending a request for a peer review on the intuitive skill(s) 118 being practiced on that day.

In some embodiments, a scoring engine 133, over a time frame such as daily, weekly, monthly and/or quarterly period, calibrates a score 125 for one or more intuitive skills 118, preferably on a competency grid 123, for each learning individual 101A. This score is based on an algorithm that takes into consideration the learning individual's 101A frequency of use, engagement, reviews, feedback loop (an opportunity for a learning individual 101A to self-evaluate themselves on the intuitive skills 118 being practiced that day with a series of questions 114) and also an opportunity for the learning individual 101A to select a peer 101B to also evaluate them on this same intuitive skills 118 using a different set of questions 114 than the ones the learning individual 101A self-evaluated themselves on.

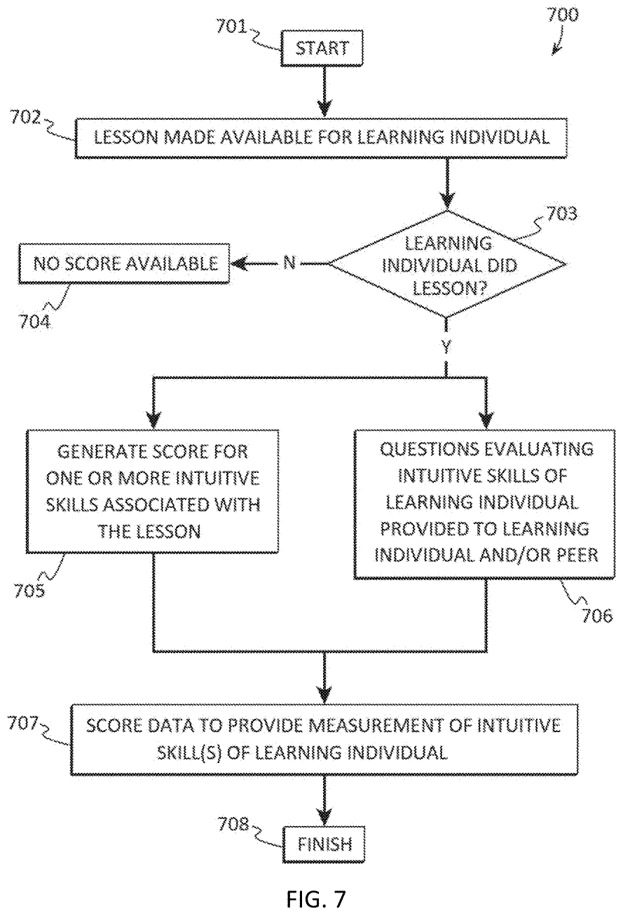

FIG. 7 depicts an example method for scoring the intuitive skills 118 (assigning a score 125) of a learning individual 101A (“the method”) 700 according to various embodiments. One or more steps of the method 700 are performed by a communication engine 131, an assessment engine 132, a scoring engine 133, a recommendation engine 134, and/or a mapping engine 135, which is executed by a computing device processor, such as a processor 302 (FIG. 2) and/or a processor 402 (FIG. 3).

In some embodiments, the method 700 starts 701 and a lesson 111 is made available for the learning individual 101A in step 702. In preferred embodiments, the client device 400 of the learning individual 101A outputs a message that a new lesson 111 available via a communication engine 131. For example, lessons 111 are released every 24 hours. Lessons 111 comprise or are associated with one or more activities 112 and quizzes 113. Preferably, each activity 112 requires a time period of engagement, such as up to 10 minutes of engagement or any other time period.

In decision block 703, the assessment engine 132 determines if the learning individual 101A did the lesson 111 using user input provided by the client device 400 of the learning individual 101A. Preferably, a learning individual 101A spends time doing activity 111 and the assessment engine 132 measures time spent and engagement on a virtual notepad or other input method. If the learning individual 101A did not do the lesson 111, the method 600 continues to step 704, in which no score is available, or the method 700 finishes 708.

If the learning individual 101A did do the lesson 111, the method 700 continues to steps 705 and 706. In step 705, the scoring engine 133 uses the input of the learning individual 101A to generate a score 125 for one or more intuitive skill 118 associated with the lesson 111. For example, the scoring engine 133 uses inputs, such as the amount of time spent, the number of types words, if all questions 114 were answered, if information was sent to a peer 101B, if the peer 101B answered all questions 114, if the lesson 111 was downloaded or otherwise accessed, and any other information provided by the learning individual 101A in response to the activities 112 and quizzes 113 of the lesson 111. In step 706, one or more questions 114 are provided to the learning individual 101A for self-evaluation and preferably one or more questions 114 are provided to peers 101B selected by the learning individual 101A for the purposes of evaluating the intuitive skills 118 of learning individual 101A. This allows the learning individual 101A to have the opportunity to do a self-review and a peer 101B review of that intuitive skill 118 being practiced on that day.

In step 707, the data of steps 705 and 706 is scored to provide a measurement or score 125 of the intuitive skills 118 of the learning individual 101A. In preferred embodiments, the scoring engine 133 compares the input of the learning individual 101A to the input of the peer 101B of step 706 to determine a score 125 of the intuitive skill 118. Preferably, the total score 125 is then weighed using a desired algorithm and a final percentage or other measurement is assigned to the learning individual 101A for the intuitive skill 118 being practiced. In further embodiments, the scoring engine 133 reviews and adjusts the intuitive skill 118 rating or score 125 based on a bell curve or other form of data fitting of the community tied to random testing of benchmarking/recognized intuitive skill 118.

In some embodiments, once the learning individual 101A has a score 125 for one or more intuitive skills 118, the scoring engine 133 visualizes and displays these scores 125 in a competency grid 123 on the display 404A of the client device 400 similar to the example of FIG. 6A. This competency grid 123 is able to be shared to anyone via various means, alongside any additional documents, which include a resume, school transcripts, and/or other documents in the profile of the learning individual 101A. In further embodiments, a competency grid 123 is also shared as a standalone document via social media profiles (e.g., LINKEDIN), employment platforms (e.g., INDEED), or any other means. In this manner, a learning individual 101A chooses to make their intuitive skills 118 scores 125, learning pathways 119, documents uploaded, or any other information public so they are searchable by employers via this data. The scores of a learning individual 101A, as well as any related data or results, are stored in one or more system databases 110, such as on a cloud based server 300. After step 707, the method 700 finishes 708.

In some embodiments, the system 100 enables a learning individual 101A to accomplish various tasks which include: finding a job 121 that matches their intuitive skills 118; improve their abilities in one or more intuitive skills 118, show more information about their abilities and intuitive skills 118 other than what is shown on a resume and/or school transcript, and/or other tasks. In further embodiments, the system 100 is further scaled to aid recruitment organizations and organization in benchmarking candidates in intuitive skills 118, such as soft skills and 21st century skills.

Various uses of the system 100 include school systems imbedding the system 100 to create a more comprehensive report card for students, which includes intuitive skills 118 and their scores 125. Job recruitment companies/portals or employment platforms (e.g., LINKEDIN, MONSTER, INDEED, etc.), also embed the system 100 such that users 101 are able to show their profiles and scores of soft skills and 21st century skills to give a truer picture of their abilities. Organizations also utilize the system, accessing a customized dashboard to build and track intuitive skills 118 of their workforce that ties to a company ROI on training and development.

In some embodiments, a communication engine 131 of the system 100 generates a web based graphical user interface allowing a user 101 to interact with the system 100 via a web-browser. In other embodiments, one or more users 101 interact with the system 100 via an application (an “app”), which is downloaded to their client device 400.

FIGS. 6A and 6B illustrate the use of the behavioral psychometric test and its implication on the habit building micro-learning as well as its use for institution level decision making. FIG. 6A shows an example of an individual competency grid 123, which is generated by a scoring engine 133, drawn from the conclusions from the learning individual's behavioral psychometric test. The top three user intuitive skills 118 coincide with the learning individual's most prominent skills 118 (having the highest scores 125) while the bottom three user intuitive skills 118 coincide with the learning individual's least prominent skills 118 (having the lowest scores 125). Based on this combination of highest and/or lowest scores 125, a learning pathway 119 is designed by the recommendation engine 134 to reinforce the most prominent skills 118 and strengthen the least prominent skills 118 through daily, weekly, or any other time interval practice of micro-learning modules comprising one or more lessons 111, activities 112, and quizzes 113 via their client device 400. It should be understood that an individual competency grid 123 and an institutional competency grid 124 comprise any number of intuitive skills 118 and scores 125.

FIG. 6B, depicts an example of an institutional competency grid 124, which is generated by a scoring engine 133, showing the user intuitive skills 118 and scores 125 of three learning individuals 101A. In some embodiments, and in this example, an institutional competency grid 124 ranks each individual member of the organization (learning individual 101A) under each intuitive skill 118. FIG. 6C shows an example of an institutional ranking grid 127, which is generated by a scoring engine 133. In some embodiments, a scoring engine 133 generates an average organization score or ranking 128 for each intuitive skill 118 and/or category of intuitive skills 118 of the one or more learning individuals 101A in the institutional competency grid 124. Based on these organization level scores or rankings 128, a preliminary debrief is prepared to guide the organization to reinforce their most prominent intuitive skills 118 and strengthen their least prominent intuitive skills 118.

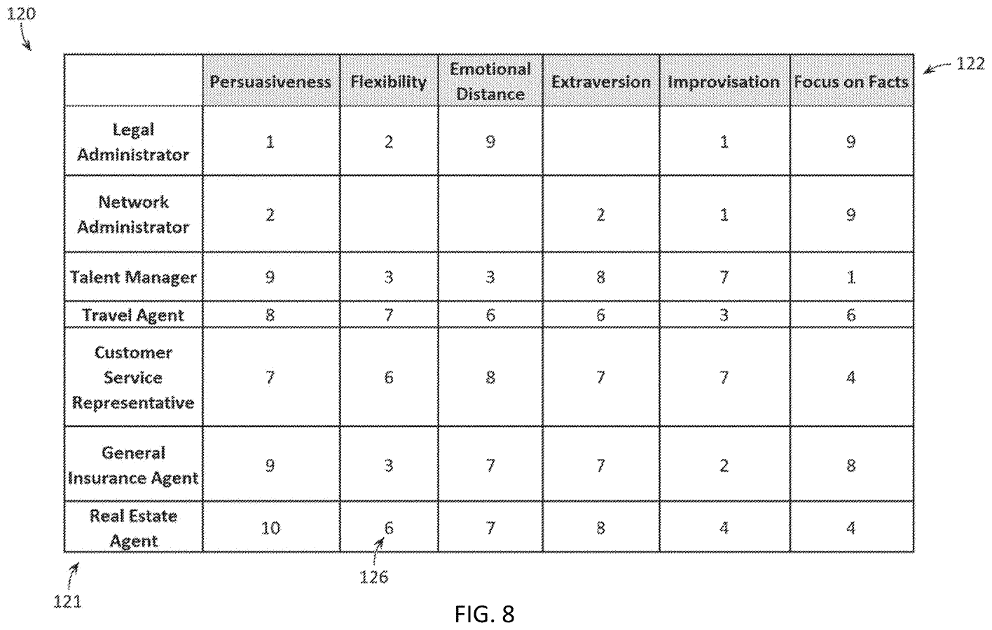

FIG. 8 illustrates a jobs and skills map data record according to one embodiment of the present invention. In some embodiments, the system 100 is configured to map the user intuitive skills 118 that a learning individual 101A has to the job intuitive skills 122 of one or more jobs 121 using the jobs and skills map data records 120. For example, a learning individual 101A named JANE wants to be a lawyer (in this example the job 121 would be lawyer). The recommendation engine 134 outputs a report showing how Jane's intuitive skills 118 are below, equal to, and/or above the job intuitive skills 122 of that lawyer job 121 using the jobs and skills map data records 120 of the lawyer job 121. First, Jane takes or performs an assessment, such as a British Psychology Approved Benchmark, which maps 200 plus behaviors to jobs. The reports compares her intuitive skills 118 to the job intuitive skills 122 to output her fitment for the lawyer job 121.

Importantly, the jobs and skills map data records 120 are not static. The jobs and skills map data records 120 include evaluations of one or more soft skills of a plurality of employees in a specific institution based on assessments conducted through the system 100, as well as performance evaluations for the work quality and/or work satisfaction of the plurality of employees based on assessments conducted by the specific institution, the system 100, and/or by third party evaluators. In one embodiment, the system 100 automatically receives updates to the records of each institution in real time. In another embodiment, the system 100 scrapes records from each institution directly or via a third-party provider at preset intervals (e.g., every 5 minutes, every 12 hours, every day, every week, etc.). Updating the jobs and skills map records 120 is advantageous, as the increasing records help to refine precisely what level of each skill is beneficial for each role, and increasing records helps to show shifts in the necessary skills for a particular job (e.g., a new technology is released, such that adaptability becomes more important for a particular role than communication). In one embodiment, the jobs and skills map records 120 automatically excludes records corresponding to employees that are no longer with the institution and/or records corresponding to employees that have not been with the institution for a set amount of time (e.g., 6 months, 1 year, 5 years, 10 years, 30 years, etc.). By excluding older records, the system is able to ensure that institutional competency grid 124 is up to date with what current employees excel, rather than what employees previously excelled.

In one embodiment, the system 100 automatically aggregates jobs and skills map records 120 from a plurality of institutions into a one or more market competency grids. Market competency grids are similar to institutional competency grids 124, with the exception that they track the necessary and/or preferred skills for a particular type of j ob across multiple employers. This is useful, as it allows a user to identify which skills are necessary to develop in order to optimize chances of finding and excelling at a job, especially if the individual is not focused on a particular employer.

In one embodiment, a machine learning module of the system 100 is operable to produce a predictive institutional competency grid 124 and/or a predictive market competency grid. In order to generate a predictive competency grid, the machine learning module determines the skills likely to increase in importance and/or decrease in importance based on updates in one or more jobs and skill data records 120 over a first preset period of time (e.g., updates in the last 6 months, updates in the last year, etc.), updates in average skills of job seekers over a second preset period of time (e.g., updates in the last 6 months, updates in the last year, etc.), and/or market news regarding a particular company and/or field (e.g., a release of a new technology, a new project started by a company, etc.). In one embodiment, the market news is automatically gathered by the system 100 using one or more web crawlers analyzing one or more predetermined sites or search engines. In one embodiment, the machine learning module automatically analyzes data gathered by the one or more web crawlers using natural language processing (NLP) and automatically correlates market news with one or more skills likely to increase or decrease in importance as a result of the market news.

Jane also wants to know what 21 century/soft skills she needs for the role. In some embodiments, the user intuitive skills 118 comprise 10 skills at varying levels to different combination of behaviors desired for job roles. For example, Persuasion as a behavior 21 century/soft skill is Communication as a user intuitive skill 118. Thinking on your Feet as a Behavior century/soft skill is Creativity as a user intuitive skill 118. Reflection as a behavior 21 century/soft skill is Mindfulness as a user intuitive skill 118. Extraversion as a Behavior 21 century/soft skill is Collaboration as a user intuitive skill 118. In preferred embodiments, user intuitive skills 118 comprise: Collaboration, Critical Thinking, Creativity, Communication, Emotional IQ, Creativity, Judgement and Decision making, Leadership, Self-Direction and/or Mindfulness.

Jane keeps reading lawyer's jobs are going to become automated and wants to explore if there are other jobs requiring the same soft skills needed for a lawyer role or some future job to be created. Next, the mapping engine 135 references the jobs and skills map data records 120, which comprise the descriptions of activities to be performed under those existing job roles in the British Psychology approved Benchmark in order to map similar job existing and future job descriptions. In some instances, job roles are combined because a future job such as a HR/AI Integrator requires a combination of several existing job roles.

In some embodiments, the system 100 is configured to accurately measure human skills and behaviors for job roles and culture fit and a candidate's or learning individual's fitment to that role and culture. Continuing the above example, Jane has the highest scores of the DC Bar. She applies for a job as a litigation lawyer at the finest litigation firm and the firm wants to verify her human skills and behaviors for the job of a lawyer after reviewing her user intuitive skills 118 compared to the job intuitive skills 122 of a litigation lawyer job 121.

Preferably, the system database 110 comprises the user's intuitive skills 118 associated with the behaviors needed for each job 121 type and also includes 25 or any number of situational judgement lessons for specific workplaces and sectors such as IT, high growth company, retail, hospitality, and/or other sectors.

The company sends situational judgement scenarios to Jane's client device 400, where certain user intuitive skills 118 would apply. Jane uses her client device 400 to type in or record her responses of how she would handle each workplace situation applying user intuitive skills 118. Jane's responses are assigned a quantitative, qualitative and 360 feedback loop score using machine learning algorithms.

In this manner, the system 100 provides a starting point of the human skills and behaviors needed for a job and where they stand after taking the benchmark. The user intuitive skills 118 mapped to their top 3 and bottom 3 behaviors are now shuffled daily for them to take micro-learning lessons (such as 5-10 minutes long) to explore culture fit, improve or develop further these skills for the desired job. The system 100 also allows a company to check the culture fit of a learning individual 101A to a job 121.

Continuing the above example, the company compares Jane's behavioral benchmark and situational judgement responses against the competency map of its workforce, top performers and lowest performing employees and maps Jane on a curve for the role she is applying for and also other roles within the company where she has equal or better fitment.

After running Jane through the process, the system 100 shows that Jane is better fitted behaviorally for an HR Litigation Research Lead Role in the company based on her user intuitive skills 118. Her user intuitive skills 118, such as judgement, decision making, thinking on her feet, organizational skills, attention to detail, and critical thinking, equals the traits of those in the law firm that are thriving and performing at an optimal level in this role. On the other hand, Jane's introversion, need to reflect, rule following tendencies, and weak persuasion skills do not make her an optimal litigation attorney.

In some embodiments, the system 100 enables a company to find out culture fit of the human behaviors and skills of a candidate. For example, a benchmark assessment is provided to the client device 400 of the top and bottom performing employees of a company. The results of the benchmark are used to create a template of what good and bad behaviors are within the company culture. User intuitive skills 118 are assigned to these behaviors such that the company understands what user intuitive skills 118 are most desired and least desired for each role according to the company culture. The scoring engine 133 generates an institutional competency grid 124 of the similar behaviors of top performers and bottom performers for easy reference. The system 100 then sends the top and bottom employees daily 5 minutes questions where they apply the user intuitive skills 118 and answer via client devices 400, such as in free text (e.g., a text message, a WHATSAPP message, a FACEBOOK message, etc.). The questions sent are chosen from a system database 110 catalogue of questions designed for specific industries and job roles.

The employees (i.e., learning individuals 101A) then answer the questions. The scoring engine 133 labels the answers of top and bottom performers with keywords, and the scoring engine 133 performs a similarity check to analyze how close someone's answer is to the ideal answer. For example, this score ranges from 0 to 1, with 1 being most similar to the ideal answer. The scoring engine 133 also provides a score (e.g., a number out of 11) to each answer of the top and bottom performer using the scoring algorithm.

Example Score Calculation:

1 Point is given if time spent by the user is 5 Minutes, else only 0.5 points are given. 1 Point is given if characters are greater than 25. 1 Point is given if the answer is meaningful (verified by PYTHON service). 1 Point is given if a self-review is submitted. 1 Point is given if only 1 rating or fewer is given a perfect 10 on scale of 0-10, else if the user has rated two out of three questions with a perfect 10, then only 0.5 points are given for the self-review. 1 point is given if a 360 review was requested.

2 points are given if a 360 feedback average matches within 2 points of the self-review on any particular skill. 1 point is given if the 360 feedback is within 4 points of the self-review on any particular skill. 3 points are given if the similarity score index is greater than 0.8, 2 points are given if the similarity score index is between 0.5 and 0.8, and 1 point is given if the similarity score index is between 0.35 and 0.49.

The scoring engine 133 then creates one or more individual competency grids 123 and/or institutional competency grids 124 having the top user intuitive skills 118 of the top and bottom performers based on the situational judgment questions. The company then combines both the competency map of Item 5 and Item 12 to adjust for culture fitment across job roles. A learning individual 101A then takes the benchmark test and now gets a fitment not only based on the system benchmark, but also based on the company combined competency map for culture fitment.

In one embodiment, the system provides an evaluation to designated top performers of a specific task or for a specific institution. The evaluation receives short answer or essay based responses to a series of questions from the top performers. Based on the responses and/or recorded text, audio, and/or video conversations with the top performers, the platform automatically builds a knowledge graph for a specific task, job, and/or institution. This knowledge graph is able to be used in training artificial intelligence modules to perform the same or a similar role.

In one embodiment, based on the results of the benchmark test, the system 100 also generates a market fitment for each individual relative to a market competency grid for a desired type of job, in addition to any score relative to a particular institutional competency grid. In one embodiment, the system 100 receives desired weightings for individual institutional competency grids that constitute the market competency grid and the fitment is generated based on a new weighted market competency grid based on those values. For example, if an unweighted market competency grid assigns a value of 3 to Flexibility, but the system 100 receives a selection to weight Google very highly and Google has a Flexibility value of 10 in its institutional competency grid, the weighted market competency grid will have a value greater than 3 (how much greater depends on the size of the market and the specific weighting selected). Importantly, both the market fitment and fitments for individual companies are dynamic scores and automatically update over time based on changes to the institutional competency grids and/or the market competency grid over time. In one embodiment, changes to the institutional competency grids and/or market competency grids arise, at least in part, based on real-time updates to data, including quantitative data for scores, relevance, and/or applications for jobs and/or activities, risk data, brand data, governance data, compliance data, and/or other market related data.

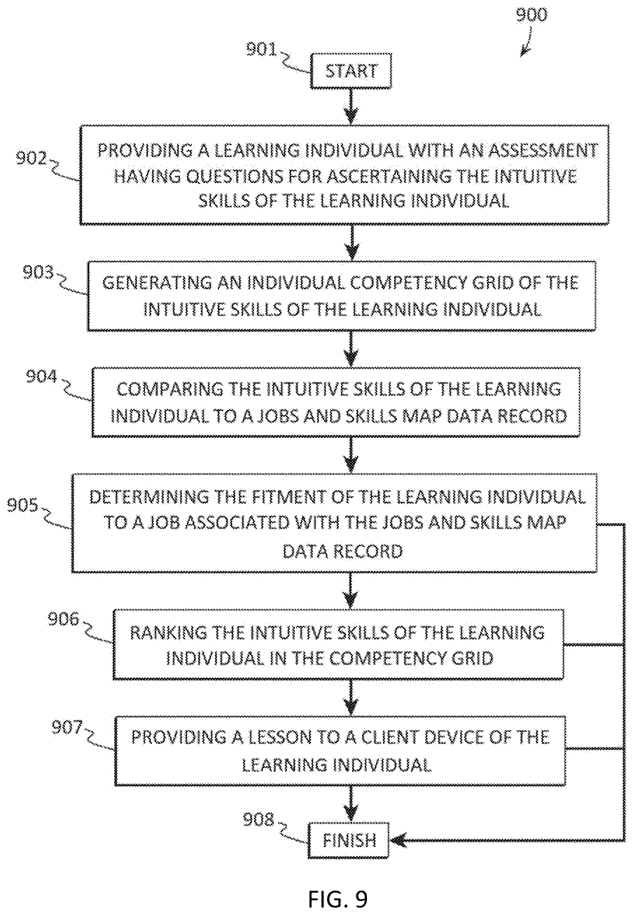

FIG. 9 depicts an example method of a computer-implemented method of individual assessment (“the method”) 900 according to various embodiments. One or more steps of the method 900 are performed by a communication engine 131, assessment engine 132, scoring engine 133, recommendation engine 134, and/or mapping engine 135, which is executed by a computing device processor, such as a processor 302, as shown in FIG. 2 and/or a processor 402, as shown in FIG. 3.

In some embodiments, the method 900 begins 901 and a learning individual 101A is provided with an assessment having questions for ascertaining the intuitive skills 118 of the learning individual 101A in step 902. For example, the learning individual 101A is provided with a British Psychology Approved Benchmark or any other assessment ascertaining the intuitive skills 118 of the learning individual 101A. In some embodiments, questions evaluating the intuitive skills 118 of the learning individual 101A are provided to one or more peers 101B.

In step 903, an individual competency grid 123 is generated with the intuitive skills 118 of the learning individual 101A. Preferably, a scoring engine 133 is configured to generate an individual competency grid 123 (a competency grid showing intuitive skills 118 of a single learning individual 101A) using the individual's 101A intuitive skills 118 scores 125 as shown in FIG. 6A. In preferred embodiments, the system database 110 comprises an individual competency grid 123 for each learning individual 101A which comprises a listing of two or more intuitive skills 118 of the learning individual 101A and a measurement or score 126 for each intuitive skill 118.

In step 904, the intuitive skills 118 of the learning individual 101A are compared to a jobs and skills map data record 120. Generally, a jobs and skills map 120 comprises one or more jobs 121 associated with one or more job intuitive skills 122 and a score 126 preferably for each job intuitive skill 122 associated with each job 121. A job data record (“job”) 121 comprises information describing a job, position, role, occupation, task, and the like, which a person, such as a user 101, performs. An intuitive skill data record (“job intuitive skill”) 122 comprises information describing an intuitive skill 122 which is used and/or not used by an individual performing that job 121. Preferably, the score 126 for each intuitive skill 122 of a job 121 describes a threshold value or minimum value that a user intuitive skill 118 score 125 should preferably meet or exceed to successfully perform the job 121. The recommendation engine 134 compares the intuitive skills 118 of the learning individual 101A to the jobs and skills map data record 120.

In step 905, the fitment of the learning individual 101A to a job 121 associated with the jobs and skills map data record 120 is determined. The recommendation engine 134 outputs a report showing whether the learning individual's 101A intuitive skills 118 are below, equal to, and/or above the job intuitive skills 122 of that job 121 using the jobs and skills map data records 120 of the job 121. After step 905, the method 900 continues to step 906 and/or 907 or finishes 908.

In optional step 906, the intuitive skills 118 of the learning individual 101A is ranked in the individual competency grid 123 as shown in FIG. 6A, such as by the skills 118 having the highest scores 125 being listed before the skills 118 having the lowest scores 125. After step 906, the method 900 continues to step 907 or finishes 908.

In optional step 907, a lesson 111, activity 112, and/or quiz 113 is provided to a client device 400 of the learning individual 101A based on the intuitive skills 118 of the learning individual 101A. In some embodiments, a push notification is provided to the client device 400 of the learning individual 101A in which the push notification notifies the learning individual 101A that the lesson is available for completion. In further embodiments, the lesson is available to the client device 400 of the learning individual 101A for a limited period of time, such as for one day, one week, etc. In further embodiments, the learning individual 101A has a limited period of time to interact with the lesson on the client device 400. After step 907, the method 900 finishes 908.

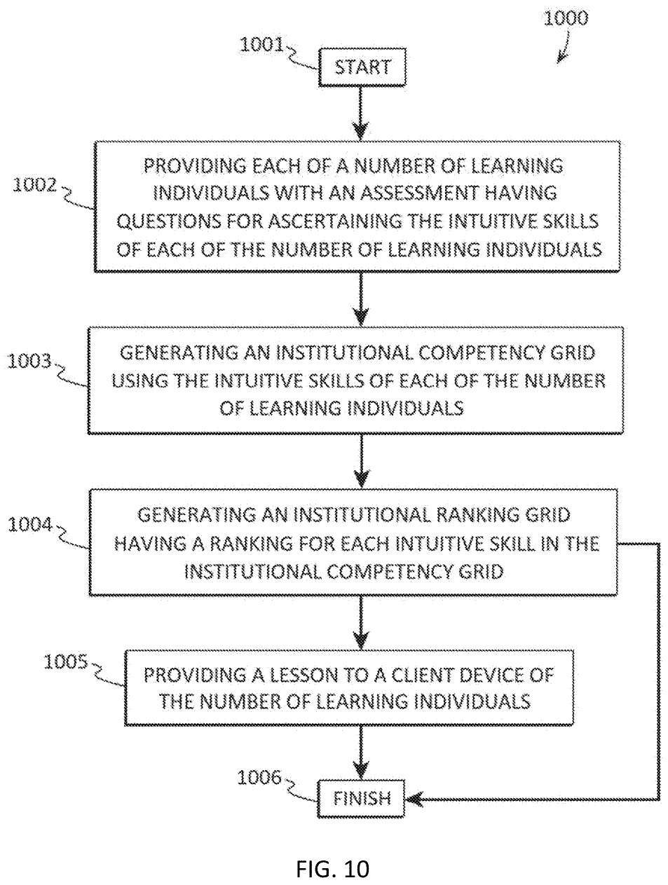

FIG. 10 illustrates an example of a computer implemented method of individual assessment (“the method”) 1000 according to various embodiments. One or more steps of the method 1000 are performed by a communication engine 131, assessment engine 132, scoring engine 133, recommendation engine 134, and/or mapping engine 135 which are executed by a computing device processor, such as a processor 302 (FIG. 2) and/or a processor 402 (FIG. 3).

In some embodiments, the method 1000 starts and a number of learning individuals 101A is provided with an assessment having questions for ascertaining the intuitive skills 118 of each of the number of learning individuals 101A in step 1002. For example, the learning individuals 101A are provided with a British Psychology Approved Benchmark or any other assessment or ascertaining the intuitive skills 118 of the learning individuals 101A. In some embodiments, questions evaluating the intuitive skills 118 of the learning individuals 101A are provided to one or more peers 101B.

In step 1003, an institutional competency grid 124 is generated using the intuitive skills 118 of each of the number of learning individuals 101A. Preferably, a scoring engine 133 is configured to generate an institutional competency grid 124 (a competency grid showing intuitive skills 118 of more than one learning individual 101A) using the individuals' 101A intuitive skills 118 scores 125, as shown in FIG. 6B. In some embodiments, the intuitive skills 118 of each of the number of learning individuals 101A is compared to one or more job intuitive skills 122 of a jobs and skills map data record 120.

In step 1004, an institutional ranking grid 127 having a ranking 128 for each intuitive skill 118 in the institutional competency grid 124 is generated by the scoring engine 133. In some embodiments, a scoring engine 133 generates an average organization score or ranking 128 for each intuitive skill 118 and/or category of intuitive skills 118 of the one or more learning individuals 101A in the institutional competency grid 124. In further embodiments, the ranking 128 for each intuitive skill 118 is generated by averaging the intuitive skills 118 of at least two learning individuals 101A of the institutional competency grid 124. After step 1004, the method 100 continues to step 1005 or finishes 1007.

In optional step 1005, a learning pathway 119, optionally comprising a lesson 111, an activity 112, and/or a quiz 113 is provided to a client device 400 of at least one of the learning individual 101A based on the intuitive skills 118 of one or more of the learning individuals 101A. In preferred embodiments, a learning pathway comprises at least one of: a lesson 111 for the lowest intuitive skill 118 of a learning individual 101A, an activity 112 for the lowest intuitive skill 118 of a learning individual 101A, and a quiz 113 for the lowest intuitive skill 118 of a learning individual 101A In some embodiments, a push notification is provided to one or more client devices 400 of one or more of the learning individuals 101A in which the push notification notifies the one or more learning individuals 101A that the lesson is available for completion. In further embodiments, the lesson is available to one or more of the client devices 400 of one or more of the learning individuals 101A for a limited period of time, such as for one day, one week, etc. In further embodiments, one or more of the learning individuals 101A has a limited period of time to interact with the lesson on the client device 400. After step 1005, the method 1000 finishes 1006.

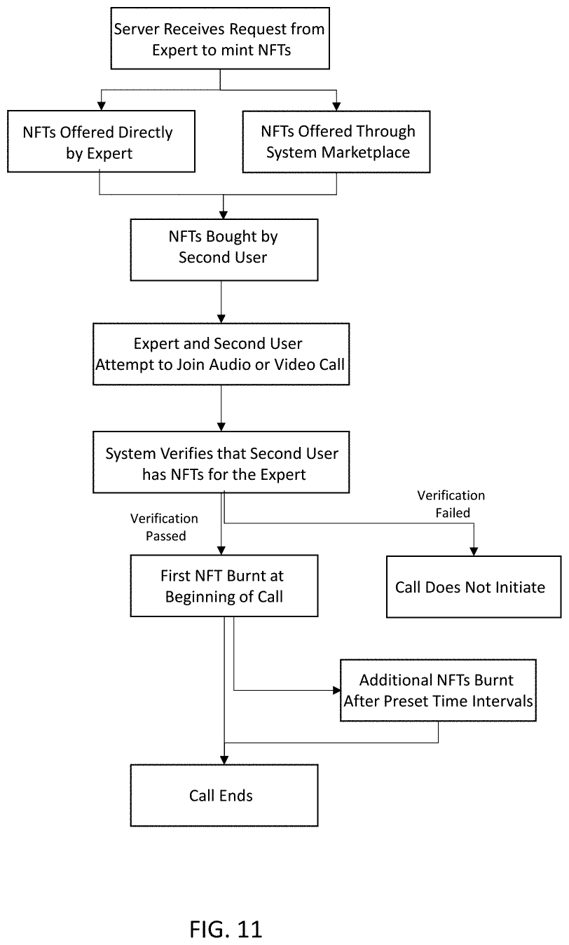

FIG. 11 illustrates a block diagram of a system for tokenizing meeting time with an expert according to one embodiment of the present invention. In one embodiment, the system provides one or more lesson videos, providing for tips and ways to improve one or more skills, preferably soft skills or 21^{st} century skills. In one embodiment, videos are created by individual experts in each topic. In one embodiment, the system provides an audio chat or video chat interface for communication between at least one user and at least one expert. In one embodiment, the system is operable to receive an input from at least one user device corresponding to an expert, wherein the input includes a number of hours offered by the expert. The system generates one or more non-fungible tokens (NFTs) corresponding to the number of hours offered by the expert. In one embodiment, each of the one or more NFTs includes information including an identity of the expert associated with the NFT, an image of the expert associated with the NFT, an amount of time provided by the NFT, and/or a specific time slot associated with the NFT. In one embodiment, all NFTs in the system correspond to an equal amount of time, but represent time with different experts and/or different time slots. In another embodiment, NFTs in the system represent different amounts of time for different experts (e.g., one NFT for a first expert represents one hour, one NFT for a second expert represents thirty minutes).

In one embodiment, the system automatically adds NFTs to a digital marketplace, wherein the NFTs are able to be purchased and/or exchanged for fiat currency, cryptocurrency, and/or one or more other NFTs. In this system, the system automatically transfers a percentage of sales for NFTs from a particular expert to a financial account and/or a cryptocurrency wallet associated with the expert (e.g., 90% of the sales amount is automatically transferred to the expert). In another embodiment, generated NFTs are automatically added to a cryptocurrency wallet associated with the expert, such that the expert is able to directly sell or exchange the NFTs. In one embodiment, holders of the NFT are expected to contact experts through third party messaging services (e.g., E-MAIL, FACEBOOK, SLACK, WHATSAPP, etc.) or through a native chat interface of the system. In one embodiment, each NFT includes at least one embedded link, which is able to access an audio chat or video chat interface. This system is particularly useful for NFTs corresponding to a specific time slot, as the audio chat or video chat interface is already set up for communication with the expert, without need for prior planning communication.

In one embodiment, the system includes at least one audio chat or video chat interface. In one embodiment, when the audio chat or video chat interface detects a first user account (e.g., corresponding to an expert) and a second user account (e.g., a holder of an NFT), the system verifies that the second user account has a valid wallet associated with the account and that the wallet includes at least one NFT corresponding to a time allotment with the first user account. If the system successfully verifies the presence of at least one NFT, then the audio chat or the video chat is able to continue. If the system is unsuccessful in verifying the presence of at least one NFT, then the audio chat or the video chat does not commence. In one embodiment, a smart contract automatically transfers a first NFT corresponding to time with the first user account to a burn wallet upon commencement of the audio chat or video chat. In one embodiment, after the audio chat or video chat has exceeded a preset duration, a smart contract automatically transfer an additional NFT corresponding to time with the first user account to a burn wallet. In one embodiment, the preset duration is an amount of time symbolized by the first NFT that was originally burnt. For example, an NFT holder holds 5 NFTs, each symbolizing one hour with the expert. Upon commencement of the audio call or the video call, a first NFT is burnt. If the audio call or the video call ends within an hour, then no additional NFTs are burnt. However, as soon as the audio call or the video call exceeds one hour, an additional NFT is burnt. In this example, the maximum length of the audio call or the video call is 5 hours, but all NFTs are burnt by the beginning of the fifth hour. In one embodiment, once no more NFTs corresponding to time with the first user account remain in the wallet of the second user account and the time corresponding to the previously burnt NFT is exceed, then the audio call and/or video call automatically ends. In one embodiment, the system automatically provides a notification a preset time period (e.g., 1 minute, 5 minutes, 10 minutes, etc.) before the audio call or video call ends, and/or before an additional NFT is required to continue the audio call or video call.

In one embodiment, the at least one NFT held in the at least one cryptocurrency wallet associated with at least one user profile is able to be used for the training for a chosen robot and/or artificial intelligence module selected by the at least one user profile. The selected robot and/or artificial intelligence module automatically participates in a machine microlesson with at least one skills and/or technological expert. In one embodiment, the robot and/or artificial intelligence module learns through natural language processing via at least one text chat interface or through natural language processing combined with speech-to-text programs via an audio chat and/or video chat. In one embodiment, based on the number of NFTs provided through the user profile, the at least one skills and/or technological expert communicates with the robot and/or artificial intelligence module for a preset amount of time (e.g., each NFT represents one hour of time). In another embodiment, based on the number of NFTs provided through the user profile, the robot and/or artificial intelligence module receives a set amount of training data stored in a database of the system (e.g., each NFT provides 1,000 previous conversations through which the artificial intelligence module is trained).

In one embodiment, microlessons teach the robot and/or artificial intelligence module to learn a specific skill (e.g., how to assemble a specific product, how to identify one or more problems with an object). In one embodiment, microlessons provide a method to further refine and develop knowledge graphs relating semantic concepts for the artificial intelligence module. In one embodiment, microlessons provide additional training data to the robot and/or artificial intelligence module. This is useful, for example, for training the robot and/or artificial intelligence module to improve the ability to communicate to humans (e.g., via a chatbot interface) and/or to develop additional microlessons for training humans on the system. Therefore, in one embodiment, at least one microlesson is automatically generated by an artificial intelligence module for a selected topic.

One of ordinary skill in the art will understand that nothing in the present application suggests that an audio chat or video chat interface is only able to include a single NFT holder and a single expert. In one embodiment, the audio chat or video chat interface includes multiple NFT holders, each of whom have at least one NFT burn at the start of the audio chat and/or video chat and when greater than a preset amount of time passes. In one embodiment, the audio chat or video chat interface includes multiple experts, and NFTs corresponding to each expert burn at the start of the audio chat and/or video chat and when greater than a preset amount of time passes for each NFT holder on the call.

One of ordinary skill in the art will understand at, as an alternative to transferring an NFT to a burn wallet, use of the NFT is able to recorded on the distributed ledger, allowing the holder of the NFT to retain the NFT as memorabilia, but denying the ability to use the NFT to access additional expert time.

In one embodiment, completion of at least one microlesson through the system and/or participation in a live call with at least one expert through the audio chat and/or video chat interface of the system by a user profile automatically mints at least one certification NFT that is automatically transferred to at least one cryptocurrency wallet associated with the user profile. The at least one certification NFT acts as proof of the acquisition of at least one skill by the user profile. Therefore, the at least one certification NFT provides a sort of “brand identity” for individual and possession of more certification NFTs acts as a proxy for the potential value of a user's work. In one embodiment, permissions for participation in at least one additional microlesson are restricted based on the at least one certification NFT present in the at least one cryptocurrency wallet associated with the user profile. For example, access to a microlesson on advanced leadership skills is only allowed for users having at least one certification NFT corresponding to a beginner-level leadership microlesson. One of ordinary skill in the art will understand that access to additional functions of the system are able to be limited to users that possess at least one specific certification NFT in the cryptocurrency wallet associated with the user profile.

In one embodiment, the system provides an audio chat and/or video chat for collaboration or brainstorming between multiple individuals. In one embodiment, the system receives a selection to designate at least one chat session as an inventive session. If the at least one chat session is designated as an inventive session, then the system automatically records the chat session and uses natural language processing to quantify and identify inventions discussed during the chat session. The system further automatically identifies which individuals are speaking during which parts of the chat session. By this method, the system automatically determines which individuals contribute to the conception of each invention mentioned during the chat session. After the chat session, the system automatically mints NFTs corresponding to each invention and transfers NFTs corresponding to each invention to at least one cryptocurrency wallet associated with user profiles detected to have contributed to each specific invention. In one embodiment, the invention NFTs include links to recordings of the chat session or one or more specific sections of the chat session determined to correspond to discussion of the specific invention represented by each specific NFT. The invention NFTs represent inventive stake in a specific invention and potential ownership stake in a resultant patent covering the invention. In one embodiment, the invention NFTs are able to be transferred to other users so as to sell ownership stake in the patent. However, the invention NFTs retain metadata regarding the original possessors of each invention NFT as proof of inventorship in the preparation of a patent application.

Systems and methods for learning through a series of micro-sessions with humans. In one embodiment of the present invention the systems and methods are provided for machine learning, i.e., a learning user or agent, wherein the learning user or agent is a machine, robot, bot, or AI-operable entity, preferably an autonomous agent or semi-autonomous agent. The micro-sessions develop data from inputs received relating to skills, including but not limited to technical skills, mechanical skills, scientific skills, and/or “soft skills” for leadership, creativity, social interaction, ethics, ingenuity, intuition, creativity, bias-identification, bias-correction, etc. in response to prompts or questions, wherein the soft skills are quantified based upon comparison to a dynamic or growing aggregation of the inputs received. The systems and methods also provide for confirmation of skill(s) acquisition by prompting for and receiving from the learning user or agent to teach the skill(s) after the micro-session.

The systems and methods of the present invention provide for predictive artificial intuition and soft skills based upon the database of content that includes teaching from micropractices or micro-sessions with human inputs received, which provide for human soft skills, human behavior, and human responses, wherein the systems and methods identify similarities and patterns across a multiplicity of human soft skills and behaviors, including but not limited to communication, creativity, judgment, entrepreneurship, collaboration, mindfulness, etc. Each micropractice or micro-session is an apprenticeship to take over a job role, wherein the content is provided in a sequence or is “journey-mapped” for a predetermined role or application of those soft skills. By way of example and not limitation, for a sales role, the micropractice or micro-session sequencing will follow a pattern of training in the soft skills for self-regulation (self-determined scheduling), conflict management, judgment, decision-making, etc. Thus, the present invention provides for a training system for agents, AI entities, bots, etc. wherein the system identifies variables and trends automatically that are required to adapt the agents, AI entities, bots, etc. for every situation and application to suit at least one role for that agent. Situations shift with context shifting, such as changes based on industry or sector, even though some underlying skills remain the same, so the systems and methods of the present invention are continuously and constantly iterating, evolving, or changing. Reconfirmation of soft skills taught to agents under these systems and methods of the present invention are made over time or over a predetermined time, e.g., six (6) months to ensure a multiplicity of interactions with the at least one agent occurs over that confirmation period.

Systems and methods for using non-fungible tokens (NFTs) for tokenizing time or contribution of experts for engaging in interactive sessions on the platform with at least one learning user (human or machine/robot/AI-operable entity). In an alternative embodiment, the systems and methods for using NFTs for tokenizing time or contribution of at least one quantified expert, human or machine, for engagement with at least one learner, wherein the at least one user is a human or machine/robot/AI-operable entity. The NFTs tokenize human behavior and/or agent behavior on the blockchain and are operable to function as a signal and as a magnet to attract information and demonstrate the brand value of at least one person or agent. It provides an association with value of the skills or soft skills. The NFTs are operable to become biometric as an authentication system for human skills in humans and non-humans, i.e., agents, robots, bots, AI entities, etc. The NFTs also represent at least one set of skills acquired by the learning user or agent, and represents at least one set of skills and a corresponding environment of experience or experiential learning. Preferably, the NFTs indicate a value associated with a learning user or agent and environment for the acquisition of and application for the skills, knowledge, soft skills, etc. The systems and methods of the present invention provide for the first NFT for an industry expert (human or agent) and their time within a marketplace. In one embodiment, the NFTs provide for access for up to a predetermined time (e.g., five (5) hours) with the at least one expert. Everything within the session, including conversation, ideas, inventions, discoveries, collaborations, intellectual property assets, etc. are also tokenized between the parties so that anything created within that session is monetizeable and allocation of that monetization to the parties is provide automatically by smart contract implemented and recorded on the immutable ledger, i.e., the blockchain. By way of example and not limitation, intellectual property rights generated by the collaboration and/or learning session(s) are captured and documented automatically and revenue generated therefrom is allocated according to the smart contracts governing the collaboration and/or learning session(s) so that all contributors receive value from the NFT associated with that time, i.e., the collaboration and/or learning session(s) and the created output therefrom, thereby providing an inventive to contribute within the session(s).

At least one dynamic data repository, wherein the data includes information captured or received from at least one of: interaction of at least two experts, interaction of at least one expert and at least one learner, questionnaire/micro-session inquiry relating to “soft skills” for leadership, creativity, social interaction, etc. in response to prompts or questions, wherein the soft skills are quantified based upon comparison to a dynamic or growing aggregation of the inputs received. Training or teaching the selected skills fills knowledge gap(s) for the learning user or agent. Knowledge graphs are generated for each of the learning agents to provide or generate at least one benchmark for artificial intelligence (AI) relating to the skills. The dynamic data includes valuable organizational data that is aggregated and analyzed in real time or near real time so that it is useful to inform and/or equip autonomous agent(s) in upskilling, discovery, and/or engagement with other agents, machines, humans, and/or AI entities. The data includes but is not limited to quantitative data for scores, relevance, and/or applications for jobs or activities around individuals and/or organizations, including risk, brand awareness, governance, compliance, and the like. The data is aggregated as a dynamic system for ongoing learning and/or certification.

Knowledge graphs used in the present invention cover a multiplicity of human skills, e.g., about ten (10) soft skills, wherein each of the skills has a corresponding plurality of behaviors associated with them. The knowledge graphs identify humans and/or agents which have the variation(s) of those behaviors in situations that would be suitable for applications in predetermined roles or job roles. Knowledge graphs are operable to identify what skills may be automated by agents, AI entities, bots, etc. In one embodiment, soft skills focused on by the present invention include collaboration, critical thinking, communication, creativity, judgment and decision making, leadership, self-direction, emotional intelligence, motivation, entrepreneurship, and/or other soft skills. In one embodiment, each skill is associated with one or more subskills. By way of example and not limitation, the collaboration skill is associated with relationship building, trust and partnership, intercultural and interpersonal fluency, conflict resolution, and/or social interdependence sub skills. By way of example and not limitation, the critical thinking skill is associated with inquiry, investigation, bias awareness, adaptive thinking, and/or problem solving subskills. By way of example and not limitation, the communication skill is associated with non-verbal communication, active listening, empathy, diversity and inclusion, and/or feedback subskills. By way of example and not limitation, the creativity skill is associated with innovation, design thinking, systems thinking, divergent/convergent thinking, and/or reframing subskills. By way of example and not limitation, the judgement and decision-making skill is associated with data and insights, risk assessment, ethics, bias awareness, and/or objectivity subskills. By way of example and not limitation, the leadership skill is associated with growth mindset, failure management, vision and values, change management, and/or style adaptation subskills. By way of example and not limitation, the self-direction skill is associated with identity, self-development and actualization, grit, self-management, and/or motivation subskills. By way of example and not limitation, the emotional intelligence skill is associated with empathy, self-regulation, stress management, influence, and/or global citizenship subskills. By way of example and not limitation, the motivation skill is associated with attention, self-awareness, vulnerability, acceptance and non-judgment, and/or meditation subskills. By way of example and not limitation, the entrepreneurship skill is associated with building and measuring products, presentation, organization, scale and social impact, and/or financial intelligence and literacy subskills.

Prior art includes publications describing static systems for training or testing soft skills for job applications or electronic learning, and the use of NFTs for electronic learning, for example with enrollment permissions. Prior art is centered around the employer or employee.

By contrast to the prior art, the present invention provides for systems and methods for learning through micro-sessions and access to at least one expert associated with a predetermined area of expertise or at least one skill.

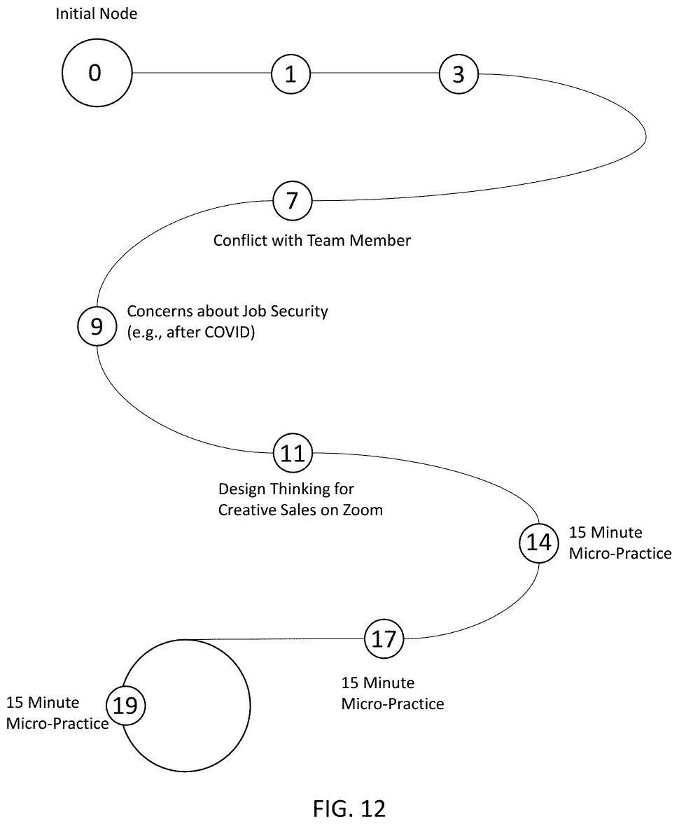

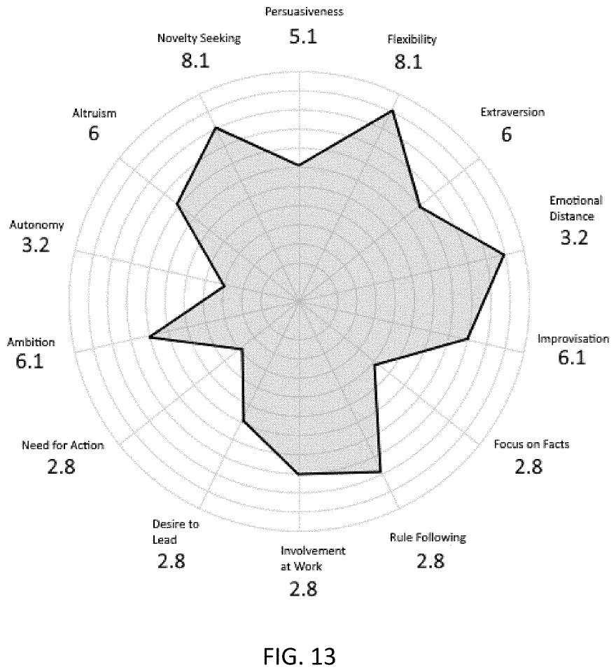

FIG. 12 illustrates a journey map according to one embodiment of the present invention. In one embodiment, the system automatically generates at least one journey map for one or more jobs. The at least one journey map includes one or more situations that come up across a typical time period (e.g., over the course of a day, a week, a month, a whole career, etc.) for at least one job performer. In one embodiment, the at least one journey map includes one or more nodes (including a starting node) indicating proficiency scores in one or more skills, as shown in FIG. 13, allowing the at least one journey map to show the development of such skills over time. In one embodiment, nodes indicate points in which skills as assessed (e.g., through a test or an evaluation), improved or taught (e.g., via a lesson), and/or challenged (e.g., through real-world application or conflict). In one embodiment, as shown in FIG. 12, journey maps including one cyclic loop, indicating a task of the same or a similar nature is repeated multiple times.

In another embodiment, the systems and methods of the present invention provide for enhancement of readiness for learning users, machines, and/or agents to upskill in one or more areas of knowledge, understanding, autonomous decision-making ability, and/or training. This includes the readiness to train another learning user, machine, and/or agent to perform a job or a role (more than a single task), wherein the readiness includes but is not limited to domain knowledge and/or the ability to manage or oversee another system, process, learning user, machine, and/or agent. In one aspect, this includes the ability to discover irrelevance in an environment where agents are actively implementing a learned skill or “soft skill.”

Data Stored on a Distributed Ledger

In a preferred embodiment, the platform is operable to store data on a distributed ledger, e.g., a blockchain. For example, in one embodiment, individual fitments and/or skills scores are automatically added to the blockchain. Updates to these fitments and/or skills scores over time causes the system to automatically write new blocks to the blockchain, reflecting these changes. Distributed ledger technology refers to an infrastructure of replicated, shared, and synchronized digital data that is decentralized and distributed across a plurality of machines, or nodes. The nodes include but are not limited to a mobile device, a computer, a server, and/or any combination thereof. Data is replicated and synchronized across a network of nodes such that each node has a complete copy of the distributed ledger. The replication and synchronization of data across a distributed set of devices provides increased transparency over traditional data storage systems, as multiple devices have access to the same set of records and/or database. Additionally, the use of distributed ledgers eliminates the need for third party and/or administrative authorities because each of the nodes in the network is operable to receive, validate, and store additional data, thus creating a truly decentralized system. Eliminating the third party and/or administrative authorities saves time and cost. A decentralized database is also more secure than traditional databases, which are stored on a single device and/or server because the decentralized data is replicated and spread out over both physical and digital space to segregated and independent nodes, making it more difficult to attack and/or irreparably tamper with the data. Tampering with the data at one location does not automatically affect the identical data stored at other nodes, thus providing greater data security.

In addition to the decentralized storage of the distributed ledger, which requires a plurality of nodes, the distributed ledger has further advantages in the way that data is received, validated, communicated, and added to the ledger. When new data is added to the distributed ledger, it must be validated by a portion of the nodes (e.g., 51%) involved in maintaining the ledger in a process called consensus. Proof of work, proof of stake, delegated proof of stake, proof of space, proof of capacity, proof of activity, proof of elapsed time, and/or proof of authority consensus are all compatible with the present invention, as are other forms of consensus known in the art. In one embodiment, the present invention uses fault-tolerant consensus systems. Each node in the system is operable to participate in consensus, e.g., by performing at least one calculation, performing at least one function, allocating compute resources, allocating at least one token, and/or storing data. It is necessary for a portion of the nodes in the system (e.g., 51% of the nodes) to participate in consensus in order for new data to be added to the distributed ledger. Advantageously, requiring that the portion of the nodes participate in consensus while all nodes are operable to participate in consensus means that authority to modify the ledger is not allocated to one node or even a group of nodes but rather is equally distributed across all of the nodes in the system. In one embodiment, a node that participates in consensus is rewarded, e.g., with a digital token, in a process called mining.

The blockchain is a commonly used implementation of a distributed ledger and was described in Satoshi Nakamoto's whitepaper Bitcoin: A Peer-to-Peer Electronic Cash System, which was published in October 2008 and which is incorporated herein by reference in its entirety. In the blockchain, additional data is added to the ledger in the form of a block. Each block is linked to its preceding block with a cryptographic hash, which is a one-way mapping function of the data in the preceding block that cannot practically be computed in reverse. In one embodiment, a timestamp is also included in the hash. The computation of the cryptographic hash based on data in a preceding block is a computationally intensive task that could not practically be conducted as a mental process. The use of cryptographic hashes means that each block is sequentially related to the block before it and the block after it, making the chain as a whole immutable. Data in a block in a preferred embodiment cannot be retroactively altered after it is added to the chain because doing so changes the associated hash, which affects all subsequent blocks in the chain and which breaks the mapping of the preceding block. The blockchain is an improvement on existing methods of data storage because it connects blocks of data in an immutable fashion. Additionally, the blockchain is then replicated and synchronized across all nodes in the system, ensuring a distributed ledger. Any attempted changes to the blockchain are propagated across a decentralized network, which increases the responsiveness of the system to detect and eliminate fraudulent behavior compared to non-distributed data storage systems. The blockchain and the distributed ledger solve problems inherent to computer networking technology by providing a secure and decentralized way of storing data that is immutable and has high fault tolerance. The distributed ledger stores digital data and is thus inextricably tied to computer technology. Additional information about the blockchain is included in The Business of Blockchain by William Mougavar published in April 2016, which is incorporated herein by reference in its entirety.

In one embodiment, the data added to the distributed ledger of the present invention include digital signatures. A digital signature links a piece of data (e.g., a block) to a digital identity (e.g., a user account). In one embodiment, the digital signature is created using a cryptographic hash and at least one private key for a user. The content of the piece of data is used to produce a cryptographic hash. The cryptographic hash and the at least one private key are used to create the digital signature using a signature algorithm. The digital signature is only operable to be created using a private key. However, the digital signature is operable to be decoded and/or verified using a public key also corresponding to the user. The separation of public keys and private keys means that external parties are able to verify a digital signature of a user using a public key but cannot replicate the digital signature since they do not have a private key. Digital signatures are not merely electronic analogs of traditional physical signatures. Physical signatures are easily accessible and easily replicable by hand. In addition, there is no standard algorithm to verify a physical signature except comparing a first signature with a second signature from the same person via visual inspection, which is not always possible. In one embodiment, the digital signatures are created using the data that is being linked to the digital identity whereas physical signatures are only related to the identity of the signer and are agnostic of what is being signed. Furthermore, digital signatures are transformed into a cryptographic hash using a private key, which is a proof of identity of which there is no physical or pre-electronic analog. Digital signatures, and cryptographic hashes in general, are of sufficient data size and complexity to not be understood by human mental work, let alone verified through the use of keys and corresponding algorithms by human mental work. Therefore, creating, decoding, and/or verifying digital signatures with the human mind is highly impractical.

Public, private, consortium, and hybrid blockchains are compatible with the present invention. In one embodiment, the blockchain system used by the present invention includes sidechains wherein the sidechains run parallel to a primary chain. Implementations of distributed ledger and/or blockchain technology including, but not limited to, BITCOIN, ETHEREUM, HASHGRAPH, BINANCE, FLOW, TRON, TEZOS, COSMOS, and/or RIPPLE are compatible with the present invention. In one embodiment, the platform includes at least one acyclic graph ledger (e.g., at least one tangle and/or at least one hashgraph). In one embodiment, the platform includes at least one quantum computing ledger.

In one embodiment, the present invention further includes the use of at least one smart contract, wherein a smart contract includes a set of automatically executable steps and/or instructions that are dependent on agreed-upon terms. The smart contract includes information including, but not limited to, at least one contracting party, at least one contract address, contract data, and/or at least one contract term. In one embodiment, the at least one smart contract is deployed on a blockchain such that the at least one smart contract is also stored on a distributed node infrastructure. In one embodiment, the terms of the at least one smart contract are dependent on changes to the blockchain. For example, a provision of the at least one smart contract executes when a new block is added to the blockchain that meets the terms of the at least one smart contract. The smart contract is preferably executed automatically when the new block is added to the blockchain. In one embodiment, a first smart contract is operable to invoke a second smart contract when executed. A smart contract is operable to capture and store state information about the current state of the blockchain and/or the distributed ledger at any point in time. Advantageously, a smart contract is more transparent than traditional coded contracts because it is stored on a distributed ledger. Additionally, all executions of the smart contract are immutably stored and accessible on the distributed ledger, which is an improvement over non-distributed, stateless coded contracts. In one embodiment, the state information is also stored on a distributed ledger.

Cryptocurrency Transactions

Distributed ledger technology further enables the use of cryptocurrencies. A cryptocurrency is a digital asset wherein ownership records and transaction records of a unit of cryptocurrency (typically a token) are stored in a digital ledger using cryptography. Use of centralized cryptocurrencies and decentralized cryptocurrencies are both compatible with the present invention. Centralized cryptocurrencies are minted prior to issuance and/or are issued by a single body. Records of a decentralized cryptocurrency are stored on a distributed ledger (e.g., a blockchain), and any node participating in the distributed ledger is operable to mint the decentralized cryptocurrency. The distributed ledger thus serves as a public record of financial transactions. Cryptocurrencies are typically fungible in that each token of a given cryptocurrency is interchangeable. The present invention is operable to facilitate transactions of at least one cryptocurrency, including, but not limited to, BITCOIN, LITECOIN, RIPPLE, NXT, DASH, STELLAR, BINANCE COIN, and/or ETHEREUM. In one embodiment, the present invention is operable to facilitate transactions of stablecoins, NEO Enhancement Protocol (NEP) tokens, and/or BINANCE Chain Evolution Proposal (BEP) tokens. In one embodiment, the present invention is operable to support tokens created using the ETHEREUM Request for Comment (ERC) standards as described by the Ethereum Improvement Proposals (EIP). For example, the present invention is operable to support ERC-20-compatible tokens, which are created using the EIP-20: ERC-20 Token Standard, published by Vogelsteller, et al., on Nov. 19, 2015, which is incorporated herein by reference in its entirety.

A cryptocurrency wallet stores keys for cryptocurrency transactions. As cryptocurrency is a virtual currency, the ability to access and transfer cryptocurrency must be protected through physical and/or virtual means such that such actions are only operable to be performed by the rightful owner and/or parties with permission. In one embodiment, a cryptocurrency wallet stores a private key and a public key. In another embodiment, the cryptocurrency wallet is operable to create the private key and/or the public key, encrypt data, and/or sign data (e.g., with a digital signature). In one embodiment, the private key is generated via a first cryptographic algorithm wherein the input to the first cryptographic algorithm is random. Alternatively, the input to the first cryptographic algorithm is non-random. In one embodiment, the public key is generated from the private key using a second cryptographic algorithm. In one embodiment, the first cryptographic algorithm and the second cryptographic algorithm are the same. The private key is only accessible to the owner of the cryptocurrency wallet, while the public key is accessible to the owner of the cryptocurrency wallet as well as a receiving party receiving cryptocurrency from the owner of the cryptocurrency wallet. Deterministic and non-deterministic cryptocurrency wallets are compatible with the present invention.

As a non-limiting example, a cryptocurrency transaction between a first party and a second party involves the first party using a private key to sign a transaction wherein the transaction includes data on a first cryptocurrency wallet belonging to the first party, the amount of the transaction, and a second cryptocurrency wallet belonging to the second party. In one embodiment, the second cryptocurrency wallet is identified by a public key. The transaction is then populated to a distributed network wherein a proportion (e.g., 51%) of the nodes of the distributed network verify the transaction. Verifying the transaction includes verifying that the private key corresponds to the first cryptocurrency wallet and that the amount of the transaction is available in the first cryptocurrency wallet. The nodes then record the transaction on the distributed ledger, e.g., by adding a block to a blockchain. Fulfilling the cryptocurrency transaction is a computationally intensive process due to key cryptography and the consensus necessary for adding data to the distributed ledger that could not practically be performed in the human mind. In one embodiment, a node is operable to verify a block of transactions rather than a single transaction.

Desktop wallets, mobile wallets, hardware wallets, and web wallets are compatible with the present invention. A software wallet (e.g., a desktop wallet, a mobile wallet, a web wallet) stores private and/or public keys in software. A hardware wallet stores and isolates private and/or public keys in a physical unit, e.g., a universal serial bus (USB) flash drive. The hardware wallet is not connected to the internet or any form of wireless communication, thus the data stored on the hardware wallet is not accessible unless the hardware wallet is connected to an external device with network connection, e.g., a computer. In one embodiment, the data on the hardware wallet is not operable to be transferred out of the hardware wallet. In one embodiment, the hardware wallet includes further data security measures, e.g., a password requirement and/or a biometric identifier requirement. In one embodiment, the present invention is operable to integrate a third-party cryptocurrency wallet. Alternatively, the present invention is operable to integrate a payments platform that is compatible with cryptocurrency, including, but not limited to, VENMO, PAYPAL, COINBASE, and/or payments platforms associated with financial institutions.

Tokenization

In one embodiment, the platform is operable to tokenize assets. A token is a piece of data that is stored on the distributed digital ledger and that is used to represent a physical and/or a digital asset, e.g., in a transaction, in an inventory. The token is not the asset itself; however, possession and transfer of the token are stored on the distributed digital ledger, thus creating an immutable record of ownership. In one embodiment, the token includes cryptographic hashes of asset data, wherein the asset data is related to the asset. In one embodiment, the asset data is a chain of data blocks. For example, the asset is a work of digital art, and the asset data includes data about the work such as information about an artist, a subject matter, a file type, color data, etc. The corresponding token includes a cryptographic hash of the asset data, which describes the work. Alternative mappings of the asset data to the token are also compatible with the present invention. In one embodiment, the token is a non-fungible token (NFT). A first non-fungible token is not directly interchangeable with a second non-fungible token; rather, the value of the first token and the second token are determined in terms of a fungible unit (e.g., a currency). In one embodiment, the platform is operable to support ETHEREUM standards for tokenization, including, but not limited to, EIP-721: ERC-721 Non-Fungible Token Standard by Entriken, et al., which was published Jan. 24, 2018 and which is incorporated herein by reference in its entirety. In one embodiment, the platform is operable to create fractional NFTs (f-NFTs), wherein each f-NFT represents a portion of the asset. Ownership of an f-NFT corresponds to partial ownership of the asset.

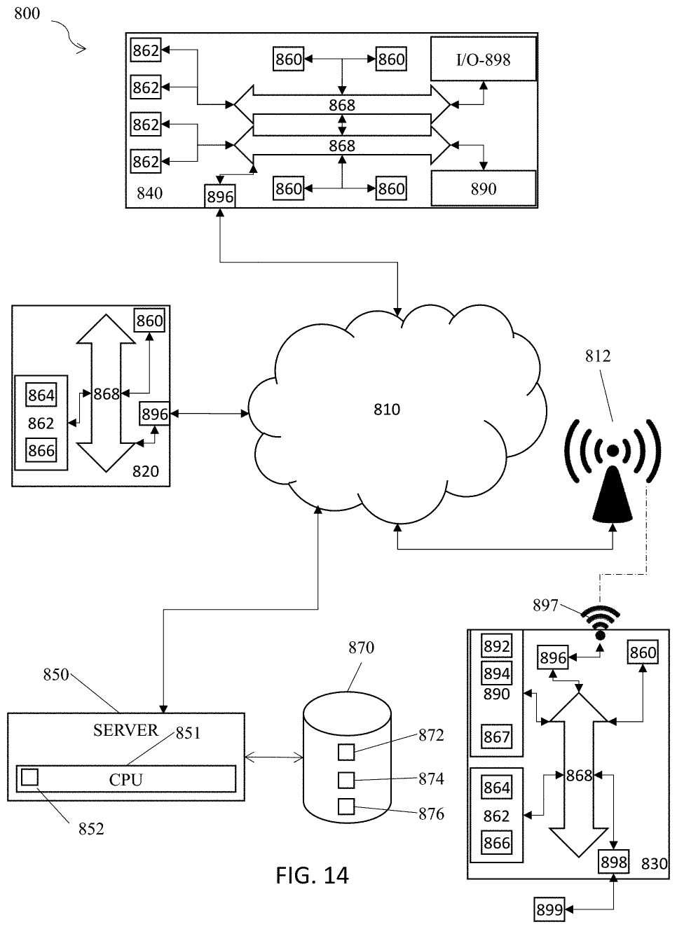

FIG. 14 is a schematic diagram of an embodiment of the invention illustrating a computer system, generally described as 800, having a network 810, a plurality of computing devices 820, 830, 840, a server 850, and a database 870.

The server 850 is constructed, configured, and coupled to enable communication over a network 810 with a plurality of computing devices 820, 830, 840. The server 850 includes a processing unit 851 with an operating system 852. The operating system 852 enables the server 850 to communicate through network 810 with the remote, distributed user devices. Database 870 is operable to house an operating system 872, memory 874, and programs 876.

In one embodiment of the invention, the system 800 includes a network 810 for distributed communication via a wireless communication antenna 812 and processing by at least one mobile communication computing device 830. Alternatively, wireless and wired communication and connectivity between devices and components described herein include wireless network communication such as WI-FI, WORLDWIDE INTEROPERABILITY FOR MICROWAVE ACCESS (WIMAX), Radio Frequency (RF) communication including RF identification (RFID), NEAR FIELD COMMUNICATION (NFC), BLUETOOTH including BLUETOOTH LOW ENERGY (BLE), ZIGBEE, Infrared (IR) communication, cellular communication, satellite communication, Universal Serial Bus (USB), Ethernet communications, communication via fiber-optic cables, coaxial cables, twisted pair cables, and/or any other type of wireless or wired communication. In another embodiment of the invention, the system 800 is a virtualized computing system capable of executing any or all aspects of software and/or application components presented herein on the computing devices 820, 830, 840. In certain aspects, the computer system 800 is operable to be implemented using hardware or a combination of software and hardware, either in a dedicated computing device, or integrated into another entity, or distributed across multiple entities or computing devices.

By way of example, and not limitation, the computing devices 820, 830, 840 are intended to represent various forms of electronic devices including at least a processor and a memory, such as a server, blade server, mainframe, mobile phone, personal digital assistant (PDA), smartphone, desktop computer, netbook computer, tablet computer, workstation, laptop, and other similar computing devices. The components shown here, their connections and relationships, and their functions, are meant to be exemplary only, and are not meant to limit implementations of the invention described and/or claimed in the present application.

In one embodiment, the computing device 820 includes components such as a processor 860, a system memory 862 having a random access memory (RAM) 864 and a read-only memory (ROM) 866, and a system bus 868 that couples the memory 862 to the processor 860. In another embodiment, the computing device 830 is operable to additionally include components such as a storage device 890 for storing the operating system 892 and one or more application programs 894, a network interface unit 896, and/or an input/output controller 898. Each of the components is operable to be coupled to each other through at least one bus 868. The input/output controller 898 is operable to receive and process input from, or provide output to, a number of other devices 899, including, but not limited to, alphanumeric input devices, mice, electronic styluses, display units, touch screens, gaming controllers, joy sticks, touch pads, signal generation devices (e.g., speakers), augmented reality/virtual reality (AR/VR) devices (e.g., AR/VR headsets), or printers.

By way of example, and not limitation, the processor 860 is operable to be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that perform calculations, process instructions for execution, and/or other manipulations of information.

In another implementation, shown as 840 in FIG. 14, multiple processors 860 and/or multiple buses 868 are operable to be used, as appropriate, along with multiple memories 862 of multiple types (e.g., a combination of a DSP and a microprocessor, a plurality of microprocessors, one or more microprocessors in conjunction with a DSP core).

Also, multiple computing devices are operable to be connected, with each device providing portions of the necessary operations (e.g., a server bank, a group of blade servers, or a multi-processor system). Alternatively, some steps or methods are operable to be performed by circuitry that is specific to a given function.

According to various embodiments, the computer system 800 is operable to operate in a networked environment using logical connections to local and/or remote computing devices 820, 830, 840 through a network 810. A computing device 830 is operable to connect to a network 810 through a network interface unit 896 connected to a bus 868. Computing devices are operable to communicate communication media through wired networks, direct-wired connections or wirelessly, such as acoustic, RF, or infrared, through an antenna 897 in communication with the network antenna 812 and the network interface unit 896, which are operable to include digital signal processing circuitry when necessary. The network interface unit 896 is operable to provide for communications under various modes or protocols.

In one or more exemplary aspects, the instructions are operable to be implemented in hardware, software, firmware, or any combinations thereof. A computer readable medium is operable to provide volatile or non-volatile storage for one or more sets of instructions, such as operating systems, data structures, program modules, applications, or other data embodying any one or more of the methodologies or functions described herein. The computer readable medium is operable to include the memory 862, the processor 860, and/or the storage media 890 and is operable be a single medium or multiple media (e.g., a centralized or distributed computer system) that store the one or more sets of instructions 867. Non-transitory computer readable media includes all computer readable media, with the sole exception being a transitory, propagating signal per se. The instructions 867 are further operable to be transmitted or received over the network 810 via the network interface unit 896 as communication media, which is operable to include a modulated data signal such as a carrier wave or other transport mechanism and includes any delivery media. The term “modulated data signal” means a signal that has one or more of its characteristics changed or set in a manner as to encode information in the signal.

Storage devices 890 and memory 862 include, but are not limited to, volatile and non-volatile media such as cache, RAM, ROM, EPROM, EEPROM, FLASH memory, or other solid state memory technology; discs (e.g., digital versatile discs (DVD), HD-DVD, BLU-RAY, compact disc (CD), or CD-ROM) or other optical storage; magnetic cassettes, magnetic tape, magnetic disk storage, floppy disks, or other magnetic storage devices; or any other medium that is used to store the computer readable instructions and which is accessed by the computer system 800.

In one embodiment, the computer system 800 is within a cloud-based network. In one embodiment, the server 850 is a designated physical server for distributed computing devices 820, 830, and 840. In one embodiment, the server 850 is a cloud-based server platform. In one embodiment, the cloud-based server platform hosts serverless functions for distributed computing devices 820, 830, and 840.

In another embodiment, the computer system 800 is within an edge computing network. The server 850 is an edge server, and the database 870 is an edge database. The edge server 850 and the edge database 870 are part of an edge computing platform. In one embodiment, the edge server 850 and the edge database 870 are designated to distributed computing devices 820, 830, and 840. In one embodiment, the edge server 850 and the edge database 870 are not designated for distributed computing devices 820, 830, and 840. The distributed computing devices 820, 830, and 840 connect to an edge server in the edge computing network based on proximity, availability, latency, bandwidth, and/or other factors.

It is also contemplated that the computer system 800 is operable to not include all of the components shown in FIG. 14, is operable to include other components that are not explicitly shown in FIG. 14, or is operable to utilize an architecture completely different than that shown in FIG. 14. The various illustrative logical blocks, modules, elements, circuits, and algorithms described in connection with the embodiments disclosed herein are operable to be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans are able to implement the described functionality in varying ways for each particular application (e.g., arranged in a different order or partitioned in a different way), but such implementation decisions should not be interpreted as causing a departure from the scope of the present invention.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A system for tokenized communication with experts via non-fungible tokens (NFTs), comprising:
a server platform configured for network communication with a plurality of user devices;
the server platform generating a plurality of user profiles, wherein each of the plurality of user profiles is associated with at least one cryptocurrency wallet;
wherein the server platform mints at least one NFT corresponding to time with at least one expert;
wherein the server platform includes at least one audio and/or video chat interface;
wherein the server platform generates an audio and/or video call between at least one first user profile and at least one second user profile;
wherein the server platform automatically verifies that the at least one cryptocurrency wallet associated with the at least one second user profile includes at least one NFT corresponding to time with the at least one first user profile;
wherein the server platform automatically transfers one of the at least one NFT corresponding to the time with the at least one first user profile to a burn wallet upon commencement of the audio and/or video call; and
wherein the server platform automatically transfers at least one additional NFT of the at least one NFT corresponding to the time with the at least one first user profile to the burn wallet after the audio and/or video call has exceeded a preset duration.

2. The system of claim 1, wherein the at least one first user profile includes a plurality of user profiles associated with designated expert users.

3. The system of claim 1, wherein the at least one second user profile includes a plurality of second user profiles, and wherein the server platform automatically verifies that the at least one cryptocurrency wallet of each of the plurality of second user profiles includes at least one NFT corresponding to the time with the at least one first user profile.

4. The system of claim 1, wherein the server platform automatically ends the audio and/or video call after a preset time period after a final one of the at least one NFT corresponding to the time with the at least one first user profile is transferred to a burn wallet.

5. The system of claim 1, wherein the server platform automatically transmits a warning notification to a user device corresponding to the at least one second user profile before the at least one additional NFT is transferred to the burn wallet.

6. The system of claim 1, wherein one or more of the at least one NFT corresponds to a specific time slot on one or more dates.

7. The system of claim 1, wherein if the verification of the at least one cryptocurrency wallet associated with the at least one second user profile fails, then the audio and/or video call does not commence.

8. The system of claim 1, wherein the server platform includes at least one NFT marketplace, wherein the server platform is configured to accept requests to purchase and/or exchange NFTs on the at least one NFT marketplace, and wherein the server platform automatically transfers funds corresponding to the purchase of the NFTs to a financial account and/or cryptocurrency wallet of at least one creator of the NFTs.

9. A system for tokenized communication with experts via non-fungible tokens (NFTs), comprising:
a server platform configured for network communication with a plurality of user devices;
the server platform generating a plurality of user profiles, wherein each of the plurality of user profiles is associated with at least one cryptocurrency wallet;
wherein the server platform mints at least one NFT corresponding to time with at least one expert;
wherein the server platform includes at least one audio and/or video chat interface;
wherein the server platform generates an audio and/or video call between at least one first user profile and a plurality of second user profiles;
wherein the server platform automatically verifies that the at least one cryptocurrency wallet associated with each of the plurality of second user profiles includes at least one NFT corresponding to time with the at least one first user profile; and
wherein, for each of the plurality of second user profiles, the server platform automatically transfers one of the at least one NFT corresponding to the time with the at least one first user profile to a burn wallet upon commencement of the audio and/or video call.

10. The system of claim 9, wherein one or more of the at least one NFT corresponds to a specific time slot on one or more dates.

11. The system of claim 9, wherein if the verification of the at least one cryptocurrency wallet associated with the plurality of second user profiles fails, then the audio and/or video call does not commence.

12. The system of claim 9, wherein the server platform includes at least one NFT marketplace, wherein the server platform is configured to accept requests to purchase and/or exchange NFTs on the at least one NFT marketplace, and wherein the server platform automatically transfers funds corresponding to the purchase of the NFTs to a financial account and/or cryptocurrency wallet of at least one creator of the NFTs.

13. The system of claim 9, wherein the server platform automatically transmits a warning notification to a user device corresponding to the plurality of second user profiles before the at least one additional NFT is transferred to the burn wallet.

14. The system of claim 9, wherein the at least one first user profile includes a plurality of user profiles associated with designated expert users.

15. The system of claim 9, wherein the server platform automatically ends the audio and/or video call after a preset time period after a final one of the at least one NFT corresponding to the time with the at least one first user profile is transferred to a burn wallet.

16. A system for tokenized communication with experts via non-fungible tokens (NFTs), comprising:
a server platform configured for network communication with a plurality of user devices;
the server platform generating a plurality of user profiles, wherein each of the plurality of user profiles is associated with at least one cryptocurrency wallet;
wherein the server platform mints at least one non-fungible token (NFT) corresponding to time with at least one expert;
wherein the server platform includes at least one audio and/or video chat interface;
wherein the server platform generates an audio and/or video call between at least one first user profile and at least one second user profile;
wherein the server platform automatically verifies that the at least one cryptocurrency wallet associated with the at least one second user profile includes at least one NFT corresponding to time with the at least one first user profile;
wherein the server platform automatically transfers one of the at least one NFT corresponding to the time with the at least one first user profile to a burn wallet upon commencement of the audio and/or video call; and
wherein the server platform automatically transmits a warning notification to a user device corresponding to the at least one second user profile before at least one additional NFT is transferred to the burn wallet.

17. The system of claim 16, wherein one or more of the at least one NFT corresponds to a specific time slot on one or more dates.

18. The system of claim 16, wherein if the verification of the at least one cryptocurrency wallet associated with the at least one second user profile fails, then the audio and/or video call does not commence.

19. The system of claim 16, wherein the server platform automatically ends the audio and/or video call after a preset time period after a final one of the at least one NFT corresponding to the time with the at least one first user profile is transferred to a burn wallet.

20. The system of claim 16, wherein the server platform includes at least one NFT marketplace, wherein the server platform is configured to accept requests to purchase and/or exchange NFTs on the at least one NFT marketplace, and wherein the server platform automatically transfers funds corresponding to the purchase of the NFTs to a financial account and/or cryptocurrency wallet of at least one creator of the NFTs.
